(19) United States
(12) Patent Application Publication
(10) Pub. No.: US 2016/0227254 A1
(43) Pub. Date: Aug. 4, 2016

(54) CODING PALETTE RUN IN PALETTE-BASED VIDEO CODING

(71) Applicant: QUALCOMM Incorporated, San Diego, CA (US)

(72) Inventors: Marta Karczewicz, San Diego, CA (US); Rajan Laxman Joshi, San Diego, CA (US); Wei Pu, Pittsburgh, PA (US); Vadim Seregin, San Diego, CA (US); Feng Zou, San Diego, CA (US)

(21) Appl. No.: 15/010,347

(22) Filed: Jan. 29, 2016

Related U.S. Application Data
(60) Provisional application No. 62/110,422, filed on Jan. 30, 2015.

(51) Int. Cl. H04N 19/70; H04N 19/176; H04N 19/43; H04N 19/597; H04N 19/105; H04N 19/13; H04N 19/61; H04N 19/593; H04N 19/52; H04N 19/117; H04N 19/186; H04N 19/124

(52) U.S. Cl. CPC H04N 19/70; H04N 19/186; H04N 19/176; H04N 19/43; H04N 19/597; H04N 19/124; H04N 19/13; H04N 19/61; H04N 19/593; H04N 19/52; H04N 19/117; H04N 19/105

(57) ABSTRACT

In general, techniques for coding video data are described. An example device for coding video data includes a memory configured to store at least a portion of the video data, and one or more processors. The one or more processors are configured to determine whether a palette run starts at a beginning of a scan-line of a block of the video data, when the palette run starts at the beginning of the scan-line, code, for the palette run, a flag that indicates whether the palette run concludes at an end of a scan-line of the block, and code the palette run based on a value of the flag.

This application claims the benefit of U.S. Provisional Application No. 62/110,422, filed 30 Jan. 2015, the entire contents of which are incorporated herein by reference.

### TECHNICAL FIELD

This disclosure relates to video encoding and decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicates the difference between the coded block and the predictive block. An intra-coded block is encoded according to an intra-coding mode and the residual data. For further compression, the residual data may be transformed from the pixel domain to a transform domain, resulting in residual coefficients, which then may be quantized. The quantized coefficients, initially arranged in a two-dimensional array, may be scanned in order to produce a one-dimensional vector of coefficients, and entropy coding may be applied to achieve even more compression.

A multiview coding bitstream may be generated by encoding views, e.g., from multiple perspectives. Some three-dimensional (3D) video standards have been developed that make use of multiview coding aspects. For example, different views may transmit left and right eye views to support 3D video. Alternatively, some 3D video coding processes may apply so-called multiview plus depth coding. In multiview plus depth coding, a 3D video bitstream may contain not only texture view components, but also depth view components. For example, each view may comprise one texture view component and one depth view component.

### SUMMARY

In general, this disclosure describes techniques related to coding video data using a palette mode. More particularly, the techniques of this disclosure are directed to coding run length values. As discussed in further detail below, a run length value is indicative of a length of a series of consecutive pixels or samples that share color information that maps to a single index of a palette that is coded for a current block. The techniques enable video coding devices, such as video encoders and/or video decoders, to leverage runs that start at the beginning of a scan-line of a palette-coded block. By leveraging information indicating that a run starts at the beginning of a line, the video coding devices may efficiently code, signal, and reconstruct samples of the palette run.

In one example, this disclosure is directed to a method of coding video data. The method includes determining whether a palette run starts at a beginning of a scan-line of a block of the video data, when the palette run starts at the beginning of the scan-line, coding, for the palette run, a flag that indicates whether the palette run concludes at an end of a scan-line of the block, and coding the palette run based on a value of the flag.

In another example, a device for coding video data includes a memory configured to store at least a portion of the video data, and one or more processors. The one or more processors are configured to determine whether a palette run starts at a beginning of a scan-line of a block of the video data, when the palette run starts at the beginning of the scan-line, code, for the palette run, a flag that indicates whether the palette run concludes at an end of a scan-line of the block, and code the palette run based on a value of the flag.

In another example, an apparatus for coding video data includes means for determining whether a palette run starts at a beginning of a scan-line of a block of the video data, means for coding, when the palette run starts at the beginning of the scan-line, for the palette run, a flag that indicates whether the palette run concludes at an end of a scan-line of the block, and means for coding the palette run based on a value of the flag.

The techniques described herein provide one or more potential advantages. For instance, video coding devices may conserve computing resources and bandwidth by leveraging information indicating that a palette run begins at the initial sample of a scan-line. Additionally, the video coding devices may maintain coding accuracy and picture quality by adhering to palette entries generated for respective samples of the block, while still mitigating the resources expended for coding the block.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video coding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIGS. 4A and 4B are block diagrams illustrating an example block of video data for coding of palette indices, in accordance with one or more aspects of this disclosure.

FIG. 5 is a flowchart illustrating an example process by which a video decoding device may perform one or more techniques of this disclosure.

FIG. 6 is a flowchart illustrating an example process by which a video encoding device may perform one or more techniques of this disclosure.

### DETAILED DESCRIPTION

This disclosure is generally related to the field of video coding, and more particularly to predicting or coding a block of video data according to palette mode. In traditional video coding, images are assumed to be continuous-tone and spatially smooth. Based on these assumptions, various tools have been developed, such as block-based transform, filtering, etc. Such tools have shown good performance for natural content videos. In applications like remote desktop, collaborative work, and wireless display, however, computer-generated screen content (e.g., such as text or computer graphics) may be the dominant content to be compressed. This type of content tends to have discrete tone, and feature sharp lines and high-contrast object boundaries. The assumption of continuous tone and smoothness may no longer apply for screen content, and thus traditional video coding techniques may not be efficient ways to compress video data including screen content.

This disclosure describes palette-based coding. Palette-based coding may be particularly suitable for screen-generated content coding. For example, assuming that a particular area of video data has a relatively small number of colors, a video coding device (e.g., a video encoder or video decoder) may form a so-called “palette” to represent the video data of the particular area. The palette may be expressed as a table of colors or pixel values representing the video data of the particular area, such as a given block. For example, the palette may include the most dominant pixel values in the given block. In some cases, the most dominant pixel values may include the one or more pixel values that occur most frequently within the block. Additionally, in some cases, a video coding device may apply a threshold value to determine whether a pixel value is to be included as one of the most dominant pixel values in the block. According to various aspects of palette-based coding, the video coding device may code index values indicative of one or more of the pixels values of the current block, instead of coding actual pixel values or their residuals for a current block of video data. In the context of palette-based coding, the index values indicate respective entries in the palette that are used to represent individual pixel values of the current block.

For example, the video encoder may encode a block of video data by determining the palette for the block (e.g., coding the palette explicitly, predicting the palette, or a combination thereof), locating an entry in the palette to represent one or more of the pixel values, and encoding the block with index values that indicate the entry in the palette used to represent the pixel values of the block. In some examples, the video encoder may signal the palette and/or the index values in an encoded bitstream. In turn, the video decoder may obtain, from an encoded bitstream, a palette for a block, as well as index values for the individual pixels of the block. The video decoder may relate the index values of the pixels to entries of the palette to reconstruct the various pixel values of the block.

High Efficiency Video Coding (HEVC) is a new video coding standard developed by the Joint Collaboration Team on Video Coding (JCT-VC) of ITU-T Video Coding Experts Group (VCEG) and ISO/IEC Motion Picture Experts Group (MPEG). A recent draft of the HEVC standard, referred to as “HEVC Draft 10” or “WD10,” is described in document JCTVC-L1003v34, Bross et al., “High Efficiency Video Coding (HEVC) Text Specification Draft 10 (for FDIS & Last Call),” Joint Collaborative Team on Video Coding (JCT-VC) of ITU-T SG16 WP3 and ISO/IEC JTC1/SC29/WG11, 12^{th} Meeting: Geneva, CH, 14-23 Jan. 2013, available from: http://phenix.int-evry.fr/jct/doc_end_user/documents/12_Geneva/wg11/JCTVC-L1003-v34.zip. The finalized HEVC standard document is published as “ITU-T H.265, SERIES H: AUDIOVISUAL AND MULTIMEDIA SYSTEMS Infrastructure of audiovisual services—Coding of moving video—High efficiency video coding,” Telecommunication Standardization Sector of International Telecommunication Union (ITU), April 2013.

To provide more efficient coding of screen-generated content, the JCT-VC is developing an extension to the HEVC standard, referred to as the HEVC Screen Content Coding (SCC) standard. A recent working draft of the HEVC SCC standard, referred to as “HEVC SCC Draft 2” or “WD2,” is described in document JCTVC-S1005, R. Joshi and J. Xu, “HEVC screen content coding draft text 2,” Joint Collaborative Team on Video Coding (JCT-VC) of ITU-T SG 16 WP 3 and ISO/IEC JTC 1/SC 29/WG 11, 19^{th} Meeting: Strasbourg, FR, 17-24 Oct. 2014.

In some examples, the palette-based coding techniques may be configured for use in one or more coding modes of the HEVC standard or the HEVC SCC standard. In other examples, the palette-based coding techniques can be used independently or as part of other existing or future systems or standards. In some examples, the techniques for palette-based coding of video data may be used with one or more other coding techniques, such as techniques for inter-predictive coding or intra-predictive coding of video data. For example, as described in greater detail below, an encoder or decoder, or combined encoder-decoder (codec), may be configured to perform inter- and intra-predictive coding, as well as palette-based coding.

With respect to the HEVC framework, as an example, the palette-based coding techniques may be configured to be used as a coding unit (CU) mode. In other examples, the palette-based coding techniques may be configured to be used as a prediction unit (PU) mode in the framework of HEVC. Accordingly, all of the following disclosed processes described in the context of a CU mode may, additionally or alternatively, apply to PU. However, these HEVC-based examples should not be considered a restriction or limitation of the palette-based coding techniques described herein. It will be appreciated that the techniques described herein may be applied to work independently or as part of other existing or yet to be developed systems/standards. In these cases, the unit for palette coding can be square blocks, rectangular blocks or even regions of non-rectangular shape.

The basic idea of palette-based coding is that, for each CU, a palette is derived which comprises (and may consist of) the most dominant pixel values in the current CU. The size and the elements of the palette are first transmitted from a video encoder to a video decoder. The size and/or the elements of the palette can be directly coded or predictively coded using the size and/or the elements of the palette in the neighboring CUs (e.g., above and/or left coded CU). After that, the pixel values in the CU are encoded based on the palette according to a certain scanning order. For each pixel location in the CU, a flag, e.g., “palette_flag” is first transmitted to indicate whether the pixel value is included in the palette, such as by mapping to an entry in the palette. For those pixel values that map to an entry in the palette, the palette index associated with that entry is signaled for the given pixel location in the CU. For those pixel values that do not exist in the palette, a special index (or “reserved” index) may be assigned to the pixel and the actual pixel value is transmitted for the given pixel location in the CU. Pixels with values that do not map to a palette entry for the current block are referred to as “escape pixels.” An escape pixel can be coded using any existing entropy coding method such as fixed length coding, unary coding, etc.

Techniques of this disclosure are related to screen content coding and other extensions to HEVC and other screen content video codecs. Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC). Recently, the design of a new video coding standard, namely High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). The screen content coding extension to HEVC, named SCC, is also being developed by the JCT-VC. A recent Working Draft (WD) of SCC including palette mode description is available in JCTVC-S1005, R. Joshi and J. Xu, “HEVC screen content coding draft text 2,” Joint Collaborative Team on Video Coding (JCT-VC) of ITU-T SG 16 WP 3 and ISO/IEC JTC 1/SC 29/WG 11, 19^{th} Meeting: Strasbourg, FR, 17-24 Oct. 2014.

When coding in the palette mode, every pixel of the block can be coded with any of an “index mode,” “copy mode,” or “escape” mode, excepting the very first row of the block, for which only index mode or escape mode is possible. That is, a video encoder and/or video decoder may be configured to code pixels of a block using the index mode the copy mode, and/or the escape mode. The index mode may sometimes be referred to as “value” mode. The copy mode may sometimes be referred to as “copy above” mode.

The video coding device may code the escape mode using a specific palette index to indicate this mode. For instance, the video encoder and/or video decoder may use a single “reserved” palette index to determine that a given pixel does not have a value reflected by an index of the corresponding palette, and is therefore an escape pixel. More specifically, the video encoder and/or decoder may use the same reserved palette index as a catch-all for all escape pixels of the block, even if multiple escape pixels differ in terms of their actual pixel values. In some examples, such as in the current version of palette coding specified in HEVC SCC, the reserved index is equal to the palette size. For pixels in escape mode, for each component, component values (possibly quantized) are also coded in the bitstream as “palette_escape_val.” For purposes of this disclosure, it can be assumed that escape pixels are coded by assigning each escape pixel a particular index. Escape pixels may be coded in this manner according to either index mode or copy mode. The described technique of coding escape pixels is not restrictive, but rather, a non-limiting example.

The syntax element “palette_run_type_flag” indicates whether index mode or copy mode is used for coding the respective pixel(s). In the case of coding according to index mode, the video encoder may signal a palette index (e.g., by way of the syntax element “palette_index”) along with a run value (e.g., by way of the syntax element “palette_run”). The run value indicates the number of subsequent consecutive pixels that will have the same palette index. According to the copy mode, the video encoder may signal only the run value to indicate the number of subsequent pixels for which the palette index is copied from the pixels located directly above the current pixel. This example pertains to cases where a horizontal traverse scan is used. In cases of vertical traverse scan, the index may be copied from the pixel located directly to the left of the current pixel. A video coding device may derive the context for the run value based on the palette index in the palette Index mode. The coded value of the palette index may differ by a value of 1, in comparison to the actual palette index value. To avoid parsing dependency, the video coding device may use the coded palette index value to determine the context for the coding the palette run value. Copy mode is not enabled for the first row in the block since there are no above pixels belonging to the same block.

The video encoder may encode and signal a flag (e.g., the “palette_escape_val_present_flag” syntax element) on a per-block basis to indicate the existence of escape pixels within the respective block. For instance, the video encoder may set the palette_escape_val_present_flag equal to a value of 1 (one) to indicate that there is at least one escape pixel in the corresponding palette-coded block. Conversely, if the palette-coded block does not include any escape pixels at all, then the video encoder may set the palette_escape_val_present_flag equal to a value of 0 (zero). The size of the palette is restricted to be in the range starting at 0 going up to a maximum palette size. The video encoder may signal the maximum palette size using the syntax element “max_palette_size.”

For some palette-coded blocks, the video encoder and/or video decoder may predict the palette from the palette entries of one or more previously palette-coded blocks. In various examples, the video encoder may explicitly signal the palette as new entries, or the video encoder and/or video decoder may completely or partially reuse the palette of the previously-coded block(s). Cases in which the video coding devices completely reuse the palette of the previously coded block(s) is completely reused are referred to as instances of “palette sharing.” In palette sharing scenarios, the video encoder may signal a flag (namely, the “palette_share_flag” syntax element) to indicate that the entire palette of the previous block is reused without modification, as is.

In coding according to the palette mode, a video coding device scans the pixels of the palette-coded block in a particular order. In various examples of palette-based coding, pixel scanning of the block may be one of two types, namely, vertical traverse or horizontal traverse scanning. Horizontal traverse scanning is sometimes referred to snake scanning or snake-like scanning. For example, horizontal traverse scanning may include alternating between left-to-right and right-to-left scanning orders from one row to the next. Similarly for vertical scan, the scan alternates between top-to-bottom and bottom-to-top. In either case, the scan converts a two-dimensional block to one dimension. The scanning pattern used in the block is derived according to the flag “palette_transpose_flag,” which the video encoder may signal on a per-block unit basis.

During palette index coding, a video encoder and/or video decoder may be configured to apply a palette index adjustment process. For instance, starting from the second pixel in the block, a video encoder may apply the palette index adjustment process by checking the palette mode of the previous pixel in the applicable scan order. First, the video encoder may reduce the maximum palette index size by a value of 1 (one). If the palette mode for the previous pixel in scan order is the index mode, then the video encoder may reduce the palette index to be coded by 1 if the index is greater than or equal to the palette index for the previous pixel in scan order. Similarly, if the palette mode for the previous pixel in scan order is the copy mode, then the video encoder may reduce the palette index to be coded by 1 if the index is greater than the palette index for the pixel that is positioned directly above the current pixel. The above description is provided from the encoding side, and a corresponding process can be performed in the reverse order at the decoder side as well. More specifically, the video decoder may implement palette index adjustment in some cases of decoding a palette-coded block. For instance, the decoder may perform palette index adjustment operations that reverse the palette index adjustments that the video encoder performed in encoding the same block of video data using palette mode.

The techniques of this disclosure may provide improved efficiency when coding palette coding information. The disclosed techniques may be performed by both video encoders and video decoders when implementing palette coding. Although the techniques as described in this disclosure as being primary used in palette mode for HEVC SCC, the techniques should not be so limited. For example, the techniques may be used in an inter-stream copy mode that has been proposed for HEVC SCC.

Various ways to improve coding of the palette_run syntax element are described in U.S. Provisional Patent Application No. 62/082,514, filed Nov. 20, 2014 (hereinafter, “the '514 application”), the entire content of which is incorporated by reference herein. SCC working draft text version 2 (JCTVC-S1005) uses a truncated version of concatenation of Golomb Rice and exponential Golomb codes. The truncation is applicable both to the prefix and the suffix. According to the techniques of the '514 application, when the prefix is truncated (that is, when the prefix consists of all ones with no zero at the end), an additional flag is coded to indicate whether the run continues for the rest of the block. If the flag is 1, no further coding is necessary. If the flag is 0, the prefix is coded using truncated binary code after decrementing the maximum run value by 1.

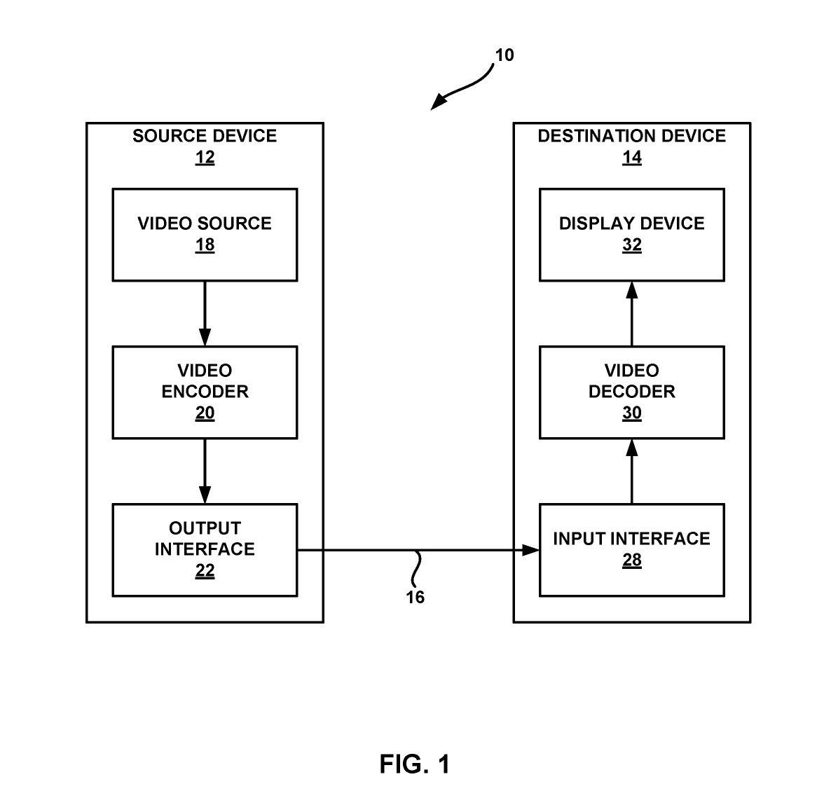

FIG. 1 is a block diagram illustrating an example video coding system 10 that may utilize the techniques of this disclosure. As used herein, the term “video coder” refers generically to both video encoders and video decoders. In this disclosure, the terms “video coding” or “coding” may refer generically to video encoding or video decoding. Video encoder 20 and video decoder 30 of video coding system 10 represent examples of devices that may be configured to perform techniques for palette-based video coding in accordance with various examples described in this disclosure. For example, video encoder 20 and video decoder 30 may be configured to selectively code various blocks of video data, such as CUs or PUs in HEVC coding, using either palette-based coding or non-palette based coding. Non-palette based coding modes may refer to various inter-predictive temporal coding modes or intra-predictive spatial coding modes, such as the various coding modes specified by HEVC Draft 10.

As shown in FIG. 1, video coding system 10 includes a source device 12 and a destination device 14. Source device 12 generates encoded video data. Accordingly, source device 12 may be referred to as a video encoding device or a video encoding apparatus. Destination device 14 may decode the encoded video data generated by source device 12. Accordingly, destination device 14 may be referred to as a video decoding device or a video decoding apparatus. Source device 12 and destination device 14 may be examples of video coding devices or video coding apparatuses.

Source device 12 and destination device 14 may comprise a wide range of devices, including desktop computers, mobile computing devices, notebook (e.g., laptop) computers, tablet computers, set-top boxes, telephone handsets such as so-called “smart” phones, televisions, cameras, display devices, digital media players, video gaming consoles, in-car computers, or the like.

Destination device 14 may receive encoded video data from source device 12 via a channel 16. Channel 16 may comprise one or more media or devices capable of moving the encoded video data from source device 12 to destination device 14. In one example, channel 16 may comprise one or more communication media that enable source device 12 to transmit encoded video data directly to destination device 14 in real-time. In this example, source device 12 may modulate the encoded video data according to a communication standard, such as a wireless communication protocol, and may transmit the modulated video data to destination device 14. The one or more communication media may include wireless and/or wired communication media, such as a radio frequency (RF) spectrum or one or more physical transmission lines. The one or more communication media may form part of a packet-based network, such as a local area network, a wide-area network, or a global network (e.g., the Internet). The one or more communication media may include routers, switches, base stations, or other equipment that facilitate communication from source device 12 to destination device 14.

In another example, channel 16 may include a storage medium that stores encoded video data generated by source device 12. In this example, destination device 14 may access the storage medium via disk access or card access. The storage medium may include a variety of locally-accessed data storage media such as Blu-ray discs, DVDs, CD-ROMs, flash memory, or other suitable digital storage media for storing encoded video data.

In a further example, channel 16 may include a file server or another intermediate storage device that stores encoded video data generated by source device 12. In this example, destination device 14 may access encoded video data stored at the file server or other intermediate storage device via streaming or download. The file server may be a type of server capable of storing encoded video data and transmitting the encoded video data to destination device 14. Example file servers include web servers (e.g., for a website), file transfer protocol (FTP) servers, network attached storage (NAS) devices, and local disk drives.

Destination device 14 may access the encoded video data through a standard data connection, such as an Internet connection. Example types of data connections may include wireless channels (e.g., Wi-Fi connections), wired connections (e.g., DSL, cable modem, etc.), or combinations of both that are suitable for accessing encoded video data stored on a file server. The transmission of encoded video data from the file server may be a streaming transmission, a download transmission, or a combination of both.

The techniques of this disclosure are not limited to wireless applications or settings. The techniques may be applied to video coding in support of a variety of multimedia applications, such as over-the-air television broadcasts, cable television transmissions, satellite television transmissions, streaming video transmissions, e.g., via the Internet, encoding of video data for storage on a data storage medium, decoding of video data stored on a data storage medium, or other applications. In some examples, video coding system 10 may be configured to support one-way or two-way video transmission to support applications such as video streaming, video playback, video broadcasting, and/or video telephony.

Video coding system 10 illustrated in FIG. 1 is merely an example and the techniques of this disclosure may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In many examples, the encoding and decoding is performed by devices that do not communicate with one another, but simply encode data to memory and/or retrieve and decode data from memory.

In the example of FIG. 1, source device 12 includes a video source 18, a video encoder 20, and an output interface 22. In some examples, output interface 22 may include a modulator/demodulator (modem) and/or a transmitter. Video source 18 may include a video capture device, e.g., a video camera, a video archive containing previously-captured video data, a video feed interface to receive video data from a video content provider, and/or a computer graphics system for generating video data, or a combination of such sources of video data.

Video encoder 20 may encode video data from video source 18. In some examples, source device 12 directly transmits the encoded video data to destination device 14 via output interface 22. In other examples, the encoded video data may also be stored onto a storage medium or a file server for later access by destination device 14 for decoding and/or playback.

In the example of FIG. 1, destination device 14 includes an input interface 28, a video decoder 30, and a display device 32. In some examples, input interface 28 includes a receiver and/or a modem. Input interface 28 may receive encoded video data over channel 16. Display device 32 may be integrated with or may be external to destination device 14. In general, display device 32 displays decoded video data. Display device 32 may comprise a variety of display devices, such as a liquid crystal display (LCD), a plasma display, an organic light emitting diode (OLED) display, or another type of display device.

This disclosure may generally refer to video encoder 20 “signaling” or “transmitting” certain information to another device, such as video decoder 30. The term “signaling” or “transmitting” may generally refer to the communication of syntax elements and/or other data used to decode the compressed video data. Such communication may occur in real- or near-real-time. Alternately, such communication may occur over a span of time, such as might occur when storing syntax elements to a computer-readable storage medium in an encoded bitstream at the time of encoding, which then may be retrieved by a decoding device at any time after being stored to this medium. Thus, while video decoder 30 may be referred to as “receiving” certain information, the receiving of information does not necessarily occur in real- or near-real-time and may be retrieved from a medium at some time after storage.

Video encoder 20 and video decoder 30 each may be implemented as any of a variety of suitable circuitry, such as one or more microprocessors, digital signal processors (DSPs), application-specific integrated circuits (ASICs), field-programmable gate arrays (FPGAs), discrete logic, hardware, or any combinations thereof If the techniques are implemented partially in software, a device may store instructions for the software in a suitable, non-transitory computer-readable storage medium and may execute the instructions in hardware using one or more processors to perform the techniques of this disclosure. Any of the foregoing (including hardware, software, a combination of hardware and software, etc.) may be considered to be one or more processors. Each of video encoder 20 and video decoder 30 may be included in one or more encoders or decoders, either of which may be integrated as part of a combined encoder/decoder (CODEC) in a respective device.

In some examples, video encoder 20 and video decoder 30 operate according to a video compression standard, such as HEVC standard mentioned above, and described in HEVC Draft 10. In addition to the base HEVC standard, there are ongoing efforts to produce scalable video coding, multiview video coding, and 3D coding extensions for HEVC. In addition, palette-based coding modes, e.g., as described in this disclosure, may be provided for extension of the HEVC standard. In some examples, the techniques described in this disclosure for palette-based coding may be applied to encoders and decoders configured to operation according to other video coding standards, such as the ITU-T-H.264/AVC standard or future standards. Accordingly, application of a palette-based coding mode for coding of coding units (CUs) or prediction units (PUs) in an HEVC codec is described for purposes of example.

In HEVC and other video coding standards, a video sequence typically includes a series of pictures. Pictures may also be referred to as “frames.” A picture may include three sample arrays, denoted S_{L}, S_{Cb} and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

To generate an encoded representation of a picture, video encoder 20 may generate a set of coding tree units (CTUs). Each of the CTUs may be a coding tree block of luma samples, two corresponding coding tree blocks of chroma samples, and syntax structures used to code the samples of the coding tree blocks. A coding tree block may be an N×N block of samples. A CTU may also be referred to as a “tree block” or a “largest coding unit” (LCU). The CTUs of HEVC may be broadly analogous to the macroblocks of other standards, such as H.264/AVC. However, a CTU is not necessarily limited to a particular size and may include one or more coding units (CUs). A slice may include an integer number of CTUs ordered consecutively in the raster scan. A coded slice may comprise a slice header and slice data. The slice header of a slice may be a syntax structure that includes syntax elements that provide information about the slice. The slice data may include coded CTUs of the slice.

This disclosure may use the term “video unit” or “video block” or “block” to refer to one or more sample blocks and syntax structures used to code samples of the one or more blocks of samples. Example types of video units or blocks may include CTUs, CUs, PUs, transform units (TUs), macroblocks, macroblock partitions, and so on. In some contexts, discussion of PUs may be interchanged with discussion of macroblocks or macroblock partitions.

To generate a coded CTU, video encoder 20 may recursively perform quad-tree partitioning on the coding tree blocks of a CTU to divide the coding tree blocks into coding blocks, hence the name “coding tree units.” A coding block is an N×N block of samples. A CU may be a coding block of luma samples and two corresponding coding blocks of chroma samples of a picture that has a luma sample array, a Cb sample array and a Cr sample array, and syntax structures used to code the samples of the coding blocks. Video encoder 20 may partition a coding block of a CU into one or more prediction blocks. A prediction block may be a rectangular (i.e., square or non-square) block of samples on which the same prediction is applied. A prediction unit (PU) of a CU may be a prediction block of luma samples, two corresponding prediction blocks of chroma samples of a picture, and syntax structures used to predict the prediction block samples. Video encoder 20 may generate predictive luma, Cb and Cr blocks for luma, Cb and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU.

If video encoder 20 uses inter prediction to generate the predictive blocks of a PU, video encoder 20 may generate the predictive blocks of the PU based on decoded samples of one or more pictures other than the picture associated with the PU. Video encoder 20 may use uni-prediction or bi-prediction to generate the predictive blocks of a PU. When video encoder 20 uses uni-prediction to generate the predictive blocks for a PU, the PU may have a single motion vector (MV). When video encoder 20 uses bi-prediction to generate the predictive blocks for a PU, the PU may have two MVs.

After video encoder 20 generates predictive blocks (e.g., predictive luma, Cb and Cr blocks) for one or more PUs of a CU, video encoder 20 may generate residual blocks for the CU. Each sample in a residual block of the CU may indicate a difference between a sample in a predictive block of a PU of the CU and a corresponding sample in a coding block of the CU. For example, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the residual blocks (e.g., luma, Cb and Cr residual blocks) of a CU into one or more transform blocks (e.g., luma, Cb and Cr transform blocks). A transform block may be a rectangular block of samples on which the same transform is applied. A transform unit (TU) of a CU may be a transform block of luma samples, two corresponding transform blocks of chroma samples, and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block.

Video encoder 20 may apply one or more transforms to a transform block to generate a coefficient block for a TU. A coefficient block may be a two-dimensional array of transform coefficients. A transform coefficient may be a scalar quantity. For example, video encoder 20 may apply one or more transforms to a luma transform block of a TU to generate a luma coefficient block for the TU. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. After video encoder 20 quantizes a coefficient block, video encoder 20 may entropy encoding syntax elements indicating the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bitstream. The bitstream may also include syntax elements that are not entropy encoded.

Video encoder 20 may output a bitstream that includes the entropy-encoded syntax elements. The bitstream may include a sequence of bits that forms a representation of coded pictures and associated data. The bitstream may comprise a sequence of network abstraction layer (NAL) units. Each of the NAL units includes a NAL unit header and encapsulates a raw byte sequence payload (RBSP). The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate an RBSP for a picture parameter set (PPS), a second type of NAL unit may encapsulate an RBSP for a coded slice, a third type of NAL unit may encapsulate an RBSP for supplemental enhancement information (SEI), and so on. NAL units that encapsulate RBSPs for video coding data (as opposed to RBSPs for parameter sets and SEI messages) may be referred to as video coding layer (VCL) NAL units.

Video decoder 30 may receive a bitstream generated by video encoder 20. In addition, video decoder 30 may obtain syntax elements from the bitstream. For example, video decoder 30 may parse the bitstream to decode syntax elements from the bitstream. Video decoder 30 may reconstruct the pictures of the video data based at least in part on the syntax elements obtained (e.g., decoded) from the bitstream. The process to reconstruct the video data may be generally reciprocal to the process performed by video encoder 20. For instance, video decoder 30 may use MVs of PUs to determine predictive sample blocks (i.e., predictive blocks) for the PUs of a current CU. In addition, video decoder 30 may inverse quantize transform coefficient blocks associated with TUs of the current CU. Video decoder 30 may perform inverse transforms on the transform coefficient blocks to reconstruct transform blocks associated with the TUs of the current CU. Video decoder 30 may reconstruct the coding blocks of the current CU by adding the samples of the predictive sample blocks for PUs of the current CU to corresponding samples of the transform blocks of the TUs of the current CU. By reconstructing the coding blocks for each CU of a picture, video decoder 30 may reconstruct the picture.

In some examples, video encoder 20 and video decoder 30 may be configured to perform palette-based coding. For example, in palette based coding, rather than performing the intra-predictive or inter-predictive coding techniques described above, video encoder 20 and video decoder 30 may code a so-called palette as a table of colors or pixel values representing the video data of a particular area (e.g., a given block). In this way, rather than coding actual pixel values or their residuals for a current block of video data, the video coder may code index values for one or more of the pixels values of the current block, where the index values indicate entries in the palette that are used to represent the pixel values of the current block.

For example, video encoder 20 may encode a block of video data by determining a palette for the block, locating an entry in the palette having a value representative of the value of one or more individual pixels of the block, and encoding the block with index values that indicate the entry in the palette used to represent the one or more individual pixel values of the block. Additionally, video encoder 20 may signal the index values in an encoded bitstream. In turn, a video decoding device (e.g., video decoder 30) may obtain, from the encoded bitstream, the palette for a block, as well as index values used for determining the various individual pixels of the block using the palette. Video decoder 30 may match the index values of the individual pixels to entries of the palette to reconstruct the pixel values of the block. In instances where the index value associated with an individual pixel does not match any index value of the corresponding palette for the block, video decoder 30 may identify such a pixel as an escape pixel, for the purposes of palette-based coding.

In another example, video encoder 20 may encode a block of video data according to the following operations. Video encoder 20 may determine prediction residual values for individual pixels of the block, determine a palette for the block, and locate an entry (e.g., index value) in the palette having a value representative of the value of one or more of the prediction residual values of the individual pixels. Additionally, video encoder 20 may encode the block with index values that indicate the entry in the palette used to represent the corresponding prediction residual value for each individual pixel of the block. Video decoder 30 may obtain, from an encoded bitstream signaled by source device 12, a palette for a block, as well as index values for the prediction residual values corresponding to the individual pixels of the block. As described, the index values may correspond to entries in the palette associated with the current block. In turn, video decoder 30 may relate the index values of the prediction residual values to entries of the palette to reconstruct the prediction residual values of the block. The prediction residual values may be added to the prediction values (for example, obtained using intra or inter prediction) to reconstruct the pixel values of the block.

As described in more detail below, the basic idea of palette-based coding is that, for a given block of video data to be coded, video encoder 20 may derive a palette that includes the most dominant pixel values in the current block. For instance, the palette may refer to a number of pixel values which are determined or assumed to be dominant and/or representative for the current CU. Video encoder 20 may first transmit the size and the elements of the palette to video decoder 30. Additionally, video encoder 20 may encode the pixel values in the given block according to a certain scanning order. For each pixel included in the given block, video encoder 20 may signal the index value that maps the pixel value to a corresponding entry in the palette. If the pixel value is not included in the palette (i.e., no palette entry exists that specifies a particular pixel value of the palette-coded block), then such a pixel is defined as an “escape pixel.” In accordance with palette-based coding, video encoder 20 may encode and signal an index value that is reserved for an escape pixel. In some examples, video encoder 20 may also encode and signal the pixel value or a residual value (or quantized versions thereof) for an escape pixel included in the given block.

Upon receiving the encoded video bitstream signaled by video encoder 20, video decoder 30 may first determine the palette based on the information received from video encoder 20. Video decoder 30 may then map the received index values associated with the pixel locations in the given block to entries of the palette to reconstruct the pixel values of the given block. In some instances, video decoder 30 may determine that a pixel of a palette-coded block is an escape pixel, such as by determining that the pixel is palette-coded with an index value reserved for escape pixels. In instances where video decoder 30 identifies an escape pixel in a palette-coded block, video decoder 30 may receive the pixel value or a residual value (or quantized versions thereof) for an escape pixel included in the given block. Video decoder 30 may reconstruct the palette-coded block by mapping the individual pixel values to the corresponding palette entries, and by using the pixel value or residual value (or quantized versions thereof) to reconstruct any escape pixels included in the palette-coded block.

In accordance with palette-based coding modes such as index mode or copy mode, video encoder 20 may encode a run value and signal the run value as part of an encoded video bitstream, which may ultimately be decoded by video decoder 30. The run value (which may be signaled by way of the “Palette_run” syntax element) indicates a number of consecutive pixels or samples in a particular scan order in a palette-coded block that are coded together. It is assumed that the current sample/pixel position is coded using the indicated run type (e.g., copy or index). The run value represents the number of subsequent samples/pixels with the same run type. The sequence of consecutive samples is referred to as a “run of samples.” In various instances of palette-based coding, the run of samples may also be referred to as a “run of palette indices,” because each sample of the run has an associated index to a palette.

The run value also indicates a run of palette indices that are coded using the same palette-coding mode. For example, with respect to index mode, video encoder 20 and/or video decoder 30 may code a palette index value, and the run value that indicates a number of subsequent consecutive samples in a scan order that share the same palette index value. Thus, with respect palette-based coding according to index mode, the run of samples represents a series of consecutive samples for which color information is represented by a single index in the palette for the current block.

With respect to copy mode, video encoder 20 and/or video decoder 30 may code an indication that an index for the current sample value is copied from an index of an above-neighboring sample (e.g., a sample that is positioned above the sample currently being coded in a block) and a run value that indicates a number of subsequent consecutive samples in a scan order that also copy a palette index from the respective above-neighboring sample and that are being coded with the palette index. Thus, with respect to copy mode according to palette-based coding, the run of samples represents a run of consecutive samples for which the palette index is copied from a respective above-neighboring palette index. This example assumes a horizontal traverse scan. In instances of vertical traverse scans, the palette indices are copied from the left-neighboring position.

Hence, the run may specify the number of subsequent samples that are coded according to the same mode. In some instances, video encoder 20 may signal an index and a run value in a manner similar to “run length coding.” In one example, a string of consecutive indices of a block may be 0, 2, 2, 2, 2, 5, where each index corresponds to a respective sample in the block. In this example, video encoder 20 may encode the second sample (e.g., the first index value of 2) using index mode. After encoding the index value of 2, video encoder 20 may code a run value of 3, to indicate that the 3 subsequent samples also share the same index value of 2. In an example of palette-based coding according to the copy mode, video encoder 20 may encode a run value of 4 after encoding an index using copy mode. In this example, video encoder 20 encodes and signals data to indicate that a total of 5 indices are copied from the corresponding indices in the row above the sample position currently being coded.

To reconstruct a palette-coded block, video decoder 30 may perform reciprocal operations to those described above with respect to video encoder 20. In the above-described example of index mode coding of a string of consecutive indices being 0, 2, 2, 2, 2, and 5, video decoder 30 may decode the index value of 2 (for the second sample), and decode a run value of 3 from the received encoded bitstream. Based on the decoded palette index of 2 and the decoded run value of 3, video decoder 30 may determine that the palette index of 2 applies to the next 3 samples that are scanned after the sample for which the index value of 2 was decoded. In the above-described example of palette-based coding according to the copy mode, video decoder 30 may decode an index for a sample by copying the index of the above-neighboring sample, and then decode a run value of 4. In this example, video decoder 30 may determine that the next 4 samples in scanning order after the copy mode-decoded sample are to be reconstructed by copying the palette index assigned to the respective above-neighboring sample. More specifically, in this example, video decoder 30 decodes data indicating that a total of 5 consecutive palette indices are to be reconstructed by copying the palette index assigned to the respective above-neighboring samples.

Techniques of this disclosure are generally directed to improving the coding of run length information in accordance with palette-based video coding. Video encoder 20 may implement one or more techniques of this disclosure to reduce the amount of information generated and signaled for run length coding of a palette-coded block. Video decoder 30 may implement the techniques to reconstruct a palette-coded block of video data without a loss in accuracy or picture quality. In this way, video encoder 20 and video decoder 30 may implement the techniques of this disclosure to conserve computing resources and bandwidth consumption, while maintaining picture quality and coding accuracy.

The techniques of this disclosure are equally applicable to alternating scans in both vertical and horizontal scan directions. For ease of discussion and illustration, the techniques are described herein with respect to alternating horizontal-direction scan. Additionally, in the examples described herein, the topmost line is scanned from left to right, the second line from the top is scanned from right to left, and the scanning direction alternates until the bottom of the block is reached. As used herein, the term “uiIdx” refers to the index (in serial number fashion) of a sample in scanning order of a palette-coded block. If the width and height of a block are expressed in terms of number of samples, then the uiIdx values of the samples range from 0 to [(width*height)−1], inclusive. Thus, the first scanned sample of the block has a uiIdx value of 0, and the last scanned sample of the block has a uiIdx value equal to the product of the width and height of the block, decremented by 1. The techniques of this disclosure are applicable to square blocks as well as non-square blocks.

According to the horizontal traverse scan order described above, the first scanned sample of the first line (row), and every odd-numbered line (row) thereafter, is the leftmost sample of the scan-line. Conversely, the first scanned sample of the second line (row), and every even-numbered line (row) thereafter, is the rightmost sample of the scan-line. As an example, in a block that that is 8 samples wide, the first line of the block has samples with uiIdx values ranging from 0 to 7 inclusive, with the first scanned sample being the sample with uiIdx 0 (hereinafter, “sample 0”). In this example, the first line of the second block is sample 8.

Video encoder 20 may implement the techniques of this disclosure to “split” the encoding process, based on the position within a scan-line at which a run begins, and the position within a scan-line at which the run ends. The terms scan-line and ‘line’ may be used interchangeably throughout this disclosure. According to some implementations, video encoder 20 may encode the palette run using the techniques described below in cases where the palette run is to be encoded in index mode or in copy mode. According to other implementations, video encoder 20 may encode the palette run using the techniques described below only in cases where the palette run is to be encoded in index mode.

First, video encoder 20 may determine whether a run starts at the beginning, i.e. at the first scanned sample, of a given scan-line. If video encoder 20 determines that the run does not start at the beginning of a scan-line, then video encoder 20 may encode the index and run value according to any applicable palette-based coding techniques described above, and/or palette-based coding techniques described in the '514 application or in WD2 of HEVC SCC.

However, if video encoder 20 determines that the run starts at the beginning of a scan-line, then video encoder 20 may implement the techniques of this disclosure to generate a flag pertaining to the current run of samples. More specifically, video encoder 20 may generate the flag to indicate whether or not the run concludes at the end, i.e. at the final scanned sample, of a line. The flag indicates whether the run concludes at the end of any scan-line, including but not limited to the scan-line in which the run begins. The flag is denoted by the “end_line_flag” syntax element in some use cases. A sample positioned at the last scanning position of a scan-line is referred to herein as an end-line sample, an end-of-line sample, or a line-ending sample.

For instance, video encoder 20 may set the flag to a value of 1 to indicate that the run concludes at the end of a scan-line. In this scenario, based on the run concluding at the end of a scan-line, video encoder 20 may encode an indication of the total number of lines encompassed by the run. For instance, if the run begins and ends in the same scan-line (in this case, spanning exactly one line), then video encoder 20 may encode an indication that the number of lines in the run is 1. As another example, if the run concludes at the end of the scan-line that is positioned immediately adjacent to (e.g., below) the scan-line in which the run began, then then video encoder 20 may encode an indication that the number of lines in the run is 2.

As an example, if video encoder 20 determines that the conditions are met for the flag to be set to a value of 1, then video encoder 20 may encode the value of the number of lines encompassed by the run, decremented by 1. In this example, if the total number of lines encompassed by the run is denoted by ‘n,’ then video encoder 20 may encode the value of (n−1) to indicate the run length in terms of lines. For instance, video encoder 20 may encode a value of 0 to indicate a run that begins and concludes in the same line. Video encoder 20 may encode a value of 1 to indicate a run that concludes in the immediately adjacent line, and so on.

As another example, video encoder 20 may use the value of 0 to indicate that the run encompasses the entire remainder of the block. More specifically, according to this example, if video encoder 20 determines that the conditions are met to set the flag to 1, and that the run concludes at the final sample of the bottommost line of the block, then video encoder 20 may encode the run length using a value of 0, regardless of the actual number of lines encompassed by the run. According to this example implementation, if video encoder 20 determines that the conditions are met for the flag to be set to 1, but that the run concludes at the end of a scan-line other than the bottommost line of the block, then video encoder 20 may encode the actual value of ‘n’ to indicate the number of lines encompassed by the run. In this example, if the run concludes at the end of the scan-line immediately adjacent to the scan-line in which the run began, then, provided that the immediately adjacent line is not the bottommost line of the block, video encoder 20 may encode a value of 2 to indicate the run length. As another example, according to this implementation, video encoder 20 may encode a value of 1 to indicate a run that begins and concludes in the same line, provided that the scan-line of the run is not the bottommost scan-line of the block. According to some implementations, video encoder 20 may use this run length coding technique only in cases where the run does not begin at the start of the block (i.e., where the uiIdx of the first sample of the run is greater than 0)

In some examples, video encoder 20 may encode the number of lines in the run using a Golomb code family, such as a Golomb Rice code, an exponential Golomb code, a Unary code, or a concatenation of Golomb Rice and exponential Golomb code. Video encoder 20 may use truncated versions of these codes may be used as well. Video encoder 20 may use a truncation that is based on (one less than) the number of samples/pixels that can be classified as scan-line-ending samples between the current pixel and the end of the block. The Rice parameter or the exponential Golomb parameter may be dependent on the bit depth.

If video encoder 20 determines that the run starts at the beginning of the scan-line and does not conclude at the end of a scan-line, then video encoder 20 may set the flag (e.g., the end_line_flag) to a value of 0. More specifically, video encoder 20 may determine that the run does not conclude at the end of a scan-line if the final sample of the run is not the final sample, in scanning order, of a scan-line. As examples, video encoder 20 may determine that the run concludes in the middle (i.e. at neither the first nor the final sample) of the same or subsequent scan-line, or at the beginning (i.e. at the first sample) of a subsequent scan-line. In some examples in which video encoder 20 determines that conditions call for the flag to be set to the 0 value, video encoder 20 may implement techniques of this disclosure to efficiently encode and signal accurate data reflecting the run length, in addition to signaling the flag.

According to one example implementation, video encoder 20 may decrement the run length by a number of ineligible run length values. By decrementing the run length value, video encoder 20 may reduce the number of bits required to be encoded, and may reduce the network bandwidth required to transmit the encoded run length value. Based on the flag being set to the 0 value, video encoder 20 may determine that various end positions for the run are not possible. As discussed above, if a run concludes at the final sample of a scan-line, then video encoder 20 sets the flag to a value of 1, in accordance with the techniques disclosed herein. Thus, video encoder 20 may determine, based on the flag being set to a value of 0, that all end-of-line samples encompassed in the run are ineligible to be the concluding point of the run. In other words, video encoder 20 may detect “holes” in the set of possible run length values, because certain run length values would cause the run to conclude at the final sample of a scan-line.

To potentially reduce the number of bits required to encode the run length in cases of the flag being set to 0, video encoder 20 may decrement the run length by the number of end-of-line instances included in the run. For instance, if the run concludes in the scan-line immediately adjacent (e.g., immediately below) the scan-line in which the run began, then video encoder 20 may decrement the run length by a value of 1. More specifically, in this particular example, video encoder 20 determines that the run includes exactly 1 end-of-line sample, namely, the final sample of the scan-line in which the run begins. If the run ends in a scan-line that is 2 lines away (e.g., below) the scan-line in which the run began, then video encoder 20 may decrement the run length by 2, and so on. In some examples of horizontal traverse scanning, video encoder 20 may determine the number of end-of-line samples in the run by dividing the run length (in samples) by the width of the block (in number of samples). For instance, video encoder 20 may discard the remainder of the division operation, and use the quotient of division operation as the number of end-of-line samples by which to decrement the run length.

According to another implementation, if video encoder 20 determines that the flag is set to the 0 value, then video encoder 20 may encode the number of lines wholly included (i.e., complete scan-lines) in the run, as well as the number of samples included in the last (incomplete) line of the run to indicate the run length. To obtain the number of samples included in the last incomplete line, video encoder 20 may perform a modulo operation with the total run length (expressed as a number of samples) as the dividend and the block width (expressed as a number of samples) as the divisor. Let the number of samples of the run positioned in the last incomplete line be denoted by the symbol ‘k’ and the number of scan-lines wholly included in the run be denoted by the symbol ‘n.’ Video encoder 20 may perform the operation (run mod width) to derive the value of k. In the formula above, ‘run’ denotes the length of the run in terms of samples. The quotient resulting from run/width (after discarding the remainder ‘k’) yields the value of n. In turn, video encoder 20 may encode the values of n and k to indicate the run length. By encoding and signaling the values of n and k, video encoder 20 may conserve computing resources and bandwidth that would otherwise be expended by using the actual run length.

Video decoder 30 may be configured to perform operations that are reciprocal to those described above with respect to video encoder 20, to reconstruct a block of encoded video data that was encoded according to one of the palette-based coding modes. For instance, video decoder 30 may implement the techniques of this disclosure to split the decoding process of a palette-coded block, using a value of a flag received in the encoded video bitstream over channel 16. According to some implementations, video decoder 30 may decode the palette run using the techniques described below in cases where the palette run is to be decoded in index mode or in copy mode. According to other implementations, video decoder 30 may decode the palette run using the techniques described below only in cases where the palette run is to be decoded in index mode. In scenarios where video decoder 30 determines that a run does not begin at the start of a scan-line, video decoder 30 may reconstruct the palette-coded block using various techniques described above, and/or decoding techniques described in the '514 application or in WD2 of HEVC SCC.

In cases where video decoder 30 determines that a run does begin at the start of a respective scan-line, video decoder 30 may use the value of a received end_line_flag (for the given run) to determine whether or not the run concludes at the end, i.e. at the final scanned sample, of a scan-line. More specifically, video decoder 30 may use the value of the flag to determine whether the run concludes at the end of any scan-line, including but not limited to the scan-line in which the run begins.

For instance, if the flag is set to a value of 1, video decoder 30 may determine that the run concludes at the end of a scan-line. In this scenario, based on the run concluding at the end of a scan-line, video decoder 30 may decode an indication of the total number of lines encompassed by the run. For instance, if the run begins and ends in the same line (in this case, spanning exactly one line), then video decoder 30 may decode an indication that the number of lines in the run is 1. As another example, if the run concludes at the end of the scan-line that is positioned immediately adjacent to (e.g., below) the scan-line in which the run began, then then video decoder 30 may decode an indication that the number of lines in the run is 2.

According to some implementations, if the flag is set to a value of 1, then video decoder 30 may receive and decode a decremented version of the number of lines encompassed by the run. As one example, video decoder 30 receives an indication in the form of a value equal to the number of lines encompassed by the run, decremented by 1. In this example, if the total number of lines encompassed by the run is denoted by ‘n,’ then video decoder 30 may recover the value of (n−1), from which video decoder 30 may derive the run length in terms of lines (e.g., by incrementing the received value by 1). For instance, if video decoder 30 decodes a value of 0 for the run length, then video decoder 30 may determine that the run is a one-line run, i.e. that the run begins and concludes in the same line. If video decoder 30 decodes a value of 1, video decoder 30 may determine that the run concludes in the immediately adjacent scan-line, and so on.

According to some implementations, video decoder 30 may determine, based on the received run length indication having a value of 0, that the run encompasses the entire remainder of the block. More specifically, according to this example, if video decoder 30 receives a flag set to the value of 1, and that the received run length indicator has a value of 0, then video decoder 30 may determine that the run concludes at the final sample of the bottommost line of the block, regardless of the actual number of lines encompassed by the run. According to this example implementation, if video decoder 30 determines that the received flag has a value of 1, and receives a non-zero value to indicate the run length, video decoder 30 may decode the received run length indication to directly obtain the actual value of the run length. More specifically, in this example, if video decoder 30 receives a value denoted by ‘n’ as the run length indicator, then video decoder 30 may determine that the value of n equals the actual number of lines encompassed by the run. In this example, video decoder 30 may decode a value of 2 from the received indication of the run length, if the run concludes at the end of the scan-line immediately adjacent to the scan-line in which the run began, then, provided that the immediately adjacent line is not the bottommost line of the block. As another example, according to this implementation, video decoder 30 may decode a run length indicator value of 1, if the run begins and concludes in the same line, provided that the lone line of the run is not the bottommost line of the block. In some implementations, video decoder 30 may decode the palette run according to this scheme only in cases where the palette run does not begin at the very first sample in the block, i.e. only when the uiIdx of the first sample of the run is greater than 0.

In some examples, video decoder 30 may receive a code or codeword, such as a Golomb Rice code, and exponential Golomb code, a Unary code, or a concatenation of a Golomb Rice code and an exponential Golomb code representing the number of lines in the run. In some examples, video decoder 30 may determine that the received code is truncated, such as by a value of one less than the number of end-line samples in the run. In these examples, video decoder 30 may reconstruct the received code, and look up the corresponding number of lines represented by the received code, by matching the reconstructed code to a code that is accessible to video decoder 30.

If video decoder 30 receives an end_line_flag set to a 0 value, then video decoder 30 may determine that the run starts at the beginning of the scan-line, but does not conclude at the end of a scan-line. More specifically, based on receiving an end_line_flag set to a 0 value, video decoder 30 may determine that the run does not conclude at the end of a scan-line, i.e. that the last sample of the run is not the final sample, in scanning order, of a respective line. In these instances, the run may conclude in the middle (i.e. at neither the first nor the final sample) of the same or subsequent scan-line, or at the beginning (i.e. at the first sample) of a subsequent scan-line. In some examples in which video decoder 30 determines that the flag is set to the 0 value, video decoder 30 may implement techniques of this disclosure to efficiently decode run length-indicating data, while maintaining accuracy and picture quality.

According to one example implementation, video decoder 30 may increment the received run length-indicating information by a number of ineligible run length values. More specifically, in these examples, video decoder 30 may increment the received value based on video encoder 20 having decremented the run length value by a commensurate amount. By obtaining the actual run length from a received decremented run length value, video decoder 30 may reduce the number of bits required to be decoded, and may reduce the network bandwidth required by another device (e.g., video encoder 20) to transmit the encoded run length value.

Based on the flag being set to the 0 value, video decoder 30 may determine that various end positions for the run are not possible. As discussed above, if a run concludes at the final sample of a scan-line, then video decoder 30 decodes a value of 1, with respect to the end_line_flag. Thus, video decoder 30 may determine, based on the flag being set to a value of 0, that all end-of-line samples encompassed in the run are ineligible to be the concluding point of the run. In other words, video decoder 30 may identify “holes” in the set of possible run length values, because certain run length values would cause the run to conclude at the final sample of a scan-line (thereby causing the flag to have a value of 1).

Based on bitrate-reducing decrementing that video encoder 20 may perform with respect to the signaled run length indication, video decoder 30 may increment the received run length indication by the number of end-of-line instances included in the run. For instance, if the run concludes in the scan-line immediately adjacent (e.g., immediately below) the scan-line in which the run began, then video decoder 30 may increment the run length-indicating information by a value of 1. More specifically, in this particular example, video decoder 30 determines that the run includes exactly 1 end-of-line sample, namely, the final sample of the scan-line in which the run begins. In turn, video decoder 30 determines that video encoder 20 decremented the run length by a value of 1 before signaling, and therefore compensates by incrementing the received information by a value of 1. If the run ends in a scan-line that is 2 lines away (e.g., below) the scan-line in which the run began, then video decoder 30 may increment the run length by 2, and so on.

In some examples of horizontal traverse scanning, video decoder 30 may determine the number of end-of-line samples in the run by dividing the run length (in samples) by the width of the block (in number of samples). For instance, video decoder 30 may discard the remainder of the division operation, and use the quotient of division operation as the number of end-of-line samples by which to decrement the run length.

According to another implementation, if video decoder 30 determines that the flag is set to the 0 value, then video decoder 30 may decode data indicating the number of lines wholly included (i.e., complete scan-lines) in the run, as well as data indicating the number of samples included in the last (incomplete) line of the run to indicate the run length. Video decoder 30 may receive and decode the value ‘n’ representing the number of whole lines included in the run, and the value ‘k’ representing the number of samples in the final incomplete line of the run. In turn, video decoder 30 may solve the formula (n*width−1)+k to obtain the actual run length, expressed as a number of samples. Video decoder 30 may have access to the width of the block (in samples), thereby enabling video decoder 30 to substitute the actual width of a given block into the formula above, to thereby obtain the run length. If video decoder 30 determines that the palette run does not begin at the start of a scan-line, then video decoder 30 may decode the palette run using any applicable palette-based coding techniques described above, and/or palette-based coding techniques described in the '514 application or in WD2 of HEVC SCC.

In this way, video encoder 20 and/or video decoder 30 may be configured to configured or otherwise operable to perform a method of coding video data. The method includes determining whether a palette run starts at a beginning of a scan-line of a block of the video data, when the palette run starts at the beginning of the scan-line, coding, for the palette run, a flag that indicates whether the palette run concludes at an end of a scan-line of the block, and coding the palette run based on a value of the flag. In some examples, coding the palette run based on the value of the flag includes performing one of: when the flag indicates that the palette run concludes at the end of a scan-line, coding a run value to indicate a number of scan-lines included in the palette run, or when the flag indicates that the palette run does not conclude at the end of a scan-line, coding the run value to indicate a number of samples included in the palette run. In some examples, when the flag indicates that the palette run concludes at the end of a scan-line, coding the run value includes coding the run value to equal one less than the number of scan-lines included in the palette run.

According to some examples, the method further includes receiving the run value as part of an encoded video bitstream, where coding the run value includes entropy decoding the run value and incrementing the decoded run value by one to obtain the number of scan-lines included in the palette run. In some examples, coding the value includes setting the run value equal to one less than the number of scan-lines included in the palette run and entropy encoding the run value, the method further including signaling the encoded value as part of an encoded video bitstream. In some examples, coding the run value includes performing one of: coding a value of zero when the palette run concludes at an end of a block, or coding the run value includes coding a value other than zero to indicate that the palette run concludes at the end of a scan-line before the end of the block.

In some instances, the method further includes receiving the flag and the run value as part of an encoded video bitstream, where when the flag indicates that the palette run does not conclude at the end of a scan-line, coding the run value includes decoding the run value by incrementing a number of samples between a start of the palette run and an end of the palette run in scanning order by a number of scan-line-ending samples included in the palette run. According to some examples, when the flag indicates that the palette run does not conclude at the end of a scan-line, coding the run value includes coding the run value by decrementing a number of samples between a start of the palette run and an end of the palette run in scanning order by a number of scan-line-ending samples included in the palette run.

According to some examples, when the flag indicates that the palette run does not conclude at the end of a scan-line, coding the run value includes: coding a first value representing the number of scan-lines included in the palette run, and coding a second value representing a number of samples included in a final scan-line of the palette run. In some examples, the method further includes receiving the first value and the second value as part of an encoded video bitstream, and determining that a total number of samples included in the palette run is represented by the formula [(n*width)−1+k], where ‘n’ represents the first value and ‘k’ represents the second value.

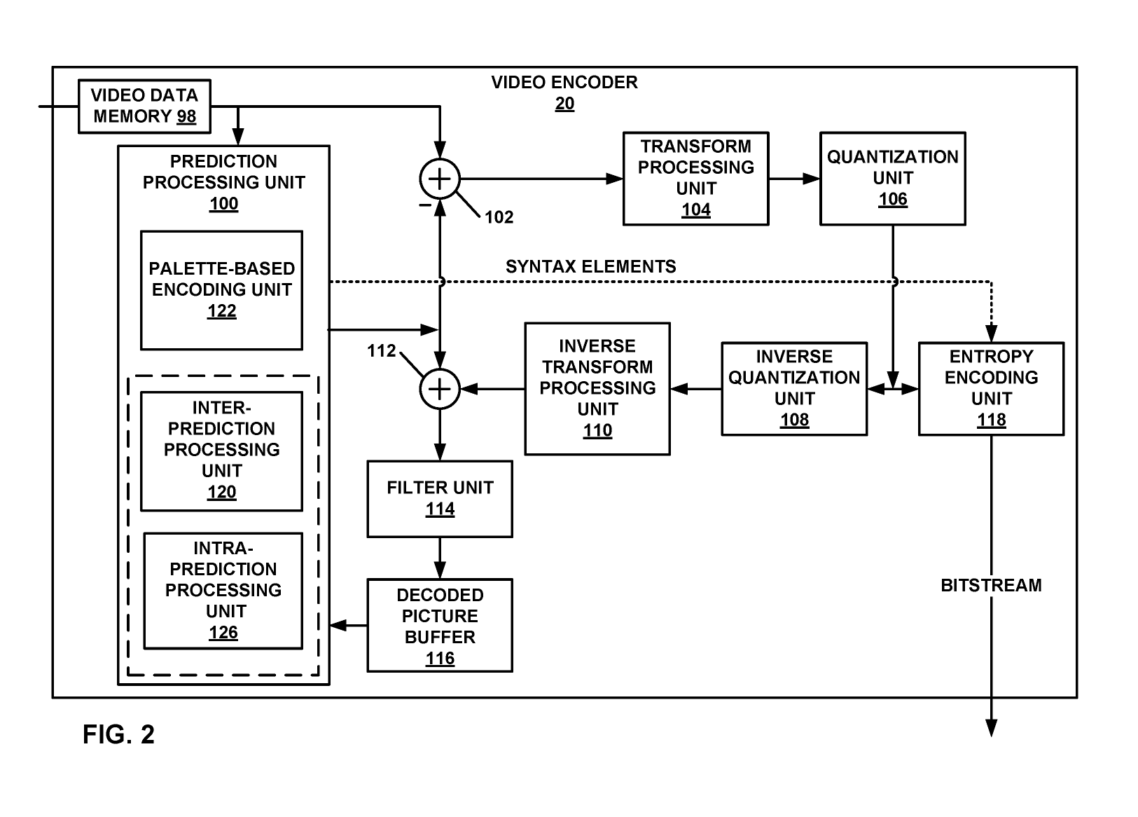

FIG. 2 is a block diagram illustrating an example video encoder 20 that may implement various techniques of this disclosure. FIG. 2 is provided for purposes of explanation and should not be considered limiting of the techniques as broadly exemplified and described in this disclosure. For purposes of explanation, this disclosure describes video encoder 20 in the context of HEVC coding. However, the techniques of this disclosure may be applicable to other coding standards or methods.

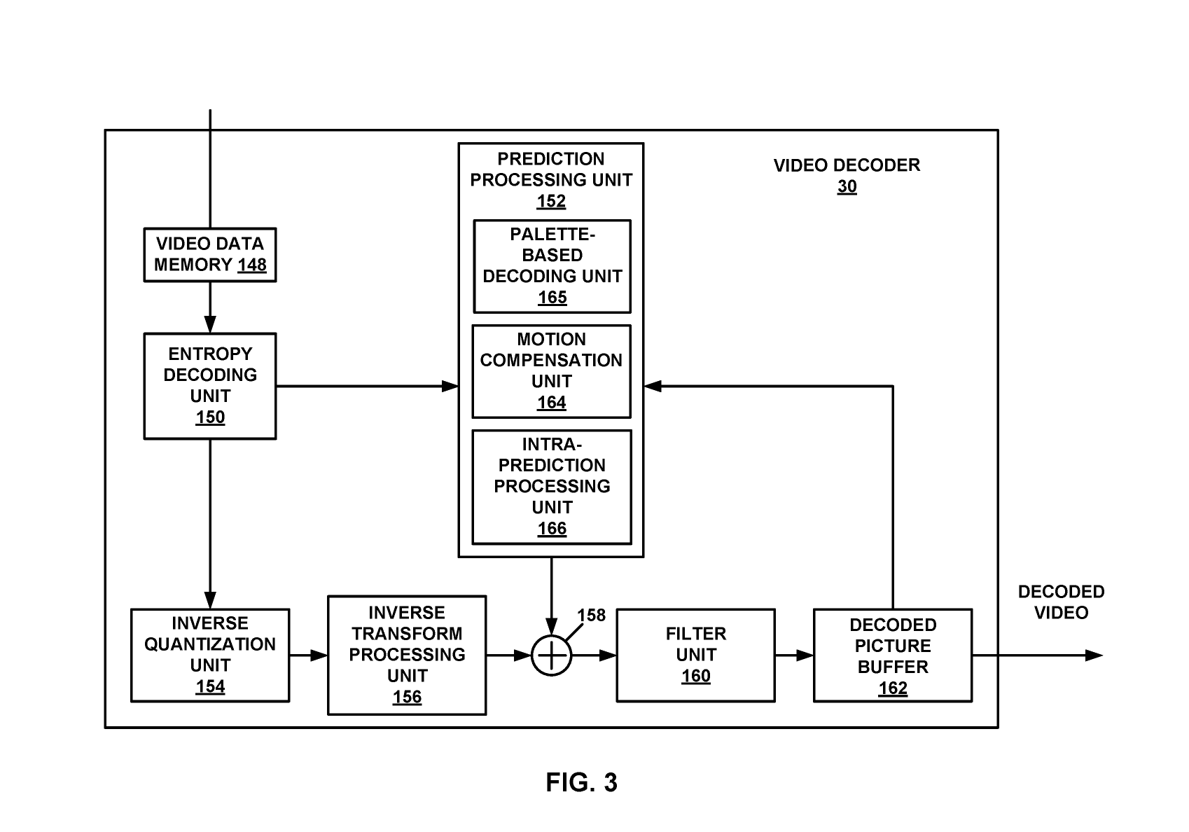

In the example of FIG. 3, video encoder 20 includes a video data memory 98, a prediction processing unit 100, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Prediction processing unit 100 includes an inter-prediction processing unit 120 and an intra-prediction processing unit 126. Inter-prediction processing unit 120 includes a motion estimation unit and a motion compensation unit (not shown). Video encoder 20 also includes a palette-based encoding unit 122 configured to perform various aspects of the palette-based coding techniques described in this disclosure. In other examples, video encoder 20 may include more, fewer, or different functional components.

Video data memory 98 may store video data to be encoded by the components of video encoder 20. The video data stored in video data memory 98 may be obtained, for example, from video source 18. Decoded picture buffer 116 may be a reference picture memory that stores reference video data for use in encoding video data by video encoder 20, e.g., in intra- or inter-coding modes. Video data memory 98 and decoded picture buffer 116 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 98 and decoded picture buffer 116 may be provided by the same memory device or separate memory devices. In various examples, video data memory 98 may be on-chip with other components of video encoder 20, or off-chip relative to those components.

Video encoder 20 may receive video data. Video encoder 20 may encode each CTU in a slice of a picture of the video data. Each of the CTUs may be associated with equally-sized luma coding tree blocks (CTBs) and corresponding CTBs of the picture. As part of encoding a CTU, prediction processing unit 100 may perform quad-tree partitioning to divide the CTBs of the CTU into progressively-smaller blocks. The smaller block may be coding blocks of CUs. For example, prediction processing unit 100 may partition a CTB associated with a CTU into four equally-sized sub-blocks, partition one or more of the sub-blocks into four equally-sized sub-sub-blocks, and so on.

Video encoder 20 may encode CUs of a CTU to generate encoded representations of the CUs (i.e., coded CUs). As part of encoding a CU, prediction processing unit 100 may partition the coding blocks associated with the CU among one or more PUs of the CU. Thus, each PU may be associated with a luma prediction block and corresponding chroma prediction blocks. Video encoder 20 and video decoder 30 may support PUs having various sizes. As indicated above, the size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction.

Inter-prediction processing unit 120 may generate predictive data for a PU by performing inter prediction on each PU of a CU. The predictive data for the PU may include one or more predictive sample blocks of the PU and motion information for the PU. Inter-prediction unit 121 may perform different operations for a PU of a CU depending on whether the PU is in an I slice, a P slice, or a B slice. In an I slice, all PUs are intra predicted. Hence, if the PU is in an I slice, inter-prediction unit 121 does not perform inter prediction on the PU. Thus, for blocks encoded in I-mode, the predictive block is formed using spatial prediction from previously-encoded neighboring blocks within the same frame.

If a PU is in a P slice, the motion estimation unit of inter-prediction processing unit 120 may search the reference pictures in a list of reference pictures (e.g., “RefPicList0”) for a reference region for the PU. The reference region for the PU may be a region, within a reference picture, that contains sample blocks that most closely correspond to the sample blocks of the PU. The motion estimation unit may generate a reference index that indicates a position in RefPicList0 of the reference picture containing the reference region for the PU. In addition, the motion estimation unit may generate an MV that indicates a spatial displacement between a coding block of the PU and a reference location associated with the reference region. For instance, the MV may be a two-dimensional vector that provides an offset from the coordinates in the current decoded picture to coordinates in a reference picture. The motion estimation unit may output the reference index and the MV as the motion information of the PU. The motion compensation unit of inter-prediction processing unit 120 may generate the predictive sample blocks of the PU based on actual or interpolated samples at the reference location indicated by the motion vector of the PU.

If a PU is in a B slice, the motion estimation unit may perform uni-prediction or bi-prediction for the PU. To perform uni-prediction for the PU, the motion estimation unit may search the reference pictures of RefPicList0 or a second reference picture list (“RefPicList1”) for a reference region for the PU. The motion estimation unit may output, as the motion information of the PU, a reference index that indicates a position in RefPicList0 or RefPicList1 of the reference picture that contains the reference region, an MV that indicates a spatial displacement between a sample block of the PU and a reference location associated with the reference region, and one or more prediction direction indicators that indicate whether the reference picture is in RefPicList0 or RefPicList1. The motion compensation unit of inter-prediction processing unit 120 may generate the predictive sample blocks of the PU based at least in part on actual or interpolated samples at the reference region indicated by the motion vector of the PU.

To perform bi-directional inter prediction for a PU, the motion estimation unit may search the reference pictures in RefPicList0 for a reference region for the PU and may also search the reference pictures in RefPicList1 for another reference region for the PU. The motion estimation unit may generate reference picture indexes that indicate positions in RefPicList0 and RefPicList1 of the reference pictures that contain the reference regions. In addition, the motion estimation unit may generate MVs that indicate spatial displacements between the reference location associated with the reference regions and a sample block of the PU. The motion information of the PU may include the reference indexes and the MVs of the PU. The motion compensation unit may generate the predictive sample blocks of the PU based at least in part on actual or interpolated samples at the reference region indicated by the motion vector of the PU.

In accordance with various examples of this disclosure, video encoder 20 may be configured to perform palette-based coding. With respect to the HEVC framework, as an example, the palette-based coding techniques may be configured to be used as a CU mode. In other examples, the palette-based coding techniques may be configured to be used as a PU mode in the framework of HEVC. Accordingly, all of the disclosed processes described herein (throughout this disclosure) in the context of a CU mode may, additionally or alternatively, apply to a PU mode. However, these HEVC-based examples should not be considered a restriction or limitation of the palette-based coding techniques described herein, as such techniques may be applied to work independently or as part of other existing or yet to be developed systems/standards. In these cases, the unit for palette coding can be square blocks, rectangular blocks or even regions of non-rectangular shape.

Palette-based encoding unit 122, for example, may perform palette-based encoding when a palette-based encoding mode is selected, e.g., for a CU or PU. For example, palette-based encoding unit 122 may be configured to generate a palette having entries indicating pixel values, select pixel values in a palette to represent pixel values of at least some positions of a block of video data, and signal information associating at least some of the positions of the block of video data with entries in the palette corresponding, respectively, to the selected pixel values. Although various functions are described as being performed by palette-based encoding unit 122, some or all of such functions may be performed by other processing units, or a combination of different processing units.

Palette-based encoding unit 122 may be configured to generate any of the various syntax elements described herein. Accordingly, video encoder 20 may be configured to encode blocks of video data using palette-based code modes as described in this disclosure. Video encoder 20 may selectively encode a block of video data using a palette coding mode, or encode a block of video data using a different mode, e.g., such an HEVC inter-predictive or intra-predictive coding mode. The block of video data may be, for example, a CU or PU generated according to an HEVC coding process. A video encoder 20 may encode some blocks with inter-predictive temporal prediction or intra-predictive spatial coding modes and decode other blocks with the palette-based coding mode.

Intra-prediction processing unit 126 may generate predictive data for a PU by performing intra prediction on the PU. The predictive data for the PU may include predictive sample blocks for the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. When using some intra prediction modes to generate a set of predictive data for the PU, intra-prediction processing unit 126 may extend values of samples from sample blocks of neighboring PUs across the predictive blocks of the PU in directions associated with the intra prediction modes. The neighboring PUs may be above, above and to the right, above and to the left, or to the left of the PU, assuming a left-to-right, top-to-bottom encoding order for PUs, CUs, and CTUs. Intra-prediction processing unit 126 may use various numbers of intra prediction modes, e.g., 33 directional intra prediction modes. In some examples, the number of intra prediction modes may depend on the size of the region associated with the PU.

Prediction processing unit 100 may select the predictive data for PUs of a CU from among the predictive data generated by inter-prediction processing unit 120 for the PUs or the predictive data generated by intra-prediction processing unit 126 for the PUs. In some examples, prediction processing unit 100 selects the predictive data for the PUs of the CU based on rate/distortion metrics of the sets of predictive data. The predictive sample blocks of the selected predictive data may be referred to herein as the selected predictive sample blocks.

Residual generation unit 102 may generate, based on the coding blocks (e.g., luma, Cb and Cr coding blocks) of a CU and the selected predictive sample blocks (e.g., predictive luma, Cb and Cr blocks) of the PUs of the CU, residual blocks (e.g., luma, Cb and Cr residual blocks) of the CU. For instance, residual generation unit 102 may generate the residual blocks of the CU such that each sample in the residual blocks has a value equal to a difference between a sample in a coding block of the CU and a corresponding sample in a corresponding selected predictive sample block of a PU of the CU.

Transform processing unit 104 may perform quad-tree partitioning to partition the residual blocks associated with a CU into transform blocks associated with TUs of the CU. Thus, in some examples, a TU may be associated with a luma transform block and two chroma transform blocks. The sizes and positions of the luma and chroma transform blocks of TUs of a CU may or may not be based on the sizes and positions of prediction blocks of the PUs of the CU. A quad-tree structure known as a “residual quad-tree” (RQT) may include nodes associated with each of the regions. The TUs of a CU may correspond to leaf nodes of the RQT.

Transform processing unit 104 may generate transform coefficient blocks for each TU of a CU by applying one or more transforms to the transform blocks of the TU. Transform processing unit 104 may apply various transforms to a transform block associated with a TU. For example, transform processing unit 104 may apply a discrete cosine transform (DCT), a directional transform, or a conceptually similar transform to a transform block. In some examples, transform processing unit 104 does not apply transforms to a transform block. In such examples, the transform block may be treated as a transform coefficient block.

Quantization unit 106 may quantize the transform coefficients in a coefficient block. The quantization process may reduce the bit depth associated with some or all of the transform coefficients. For example, an n-bit transform coefficient may be rounded down to an m-bit transform coefficient during quantization, where n is greater than m. Quantization unit 106 may quantize a coefficient block associated with a TU of a CU based on a quantization parameter (QP) value associated with the CU. Video encoder 20 may adjust the degree of quantization applied to the coefficient blocks associated with a CU by adjusting the QP value associated with the CU. Quantization may introduce loss of information, thus quantized transform coefficients may have lower precision than the original ones.

Inverse quantization unit 108 and inverse transform processing unit 110 may apply inverse quantization and inverse transforms to a coefficient block, respectively, to reconstruct a residual block from the coefficient block. Reconstruction unit 112 may add the reconstructed residual block to corresponding samples from one or more predictive sample blocks generated by prediction processing unit 100 to produce a reconstructed transform block associated with a TU. By reconstructing transform blocks for each TU of a CU in this way, video encoder 20 may reconstruct the coding blocks of the CU.

Filter unit 114 may perform one or more deblocking operations to reduce blocking artifacts in the coding blocks associated with a CU. Decoded picture buffer 116 may store the reconstructed coding blocks after filter unit 114 performs the one or more deblocking operations on the reconstructed coding blocks. Inter-prediction processing unit 120 may use a reference picture that contains the reconstructed coding blocks to perform inter prediction on PUs of other pictures. In addition, intra-prediction processing unit 126 may use reconstructed coding blocks in decoded picture buffer 116 to perform intra prediction on other PUs in the same picture as the CU.

Entropy encoding unit 118 may receive data from other functional components of video encoder 20. For example, entropy encoding unit 118 may receive coefficient blocks from quantization unit 106 and may receive syntax elements from prediction processing unit 100. Entropy encoding unit 118 may perform one or more entropy encoding operations on the data to generate entropy-encoded data. For example, entropy encoding unit 118 may perform a CABAC operation, a context-adaptive variable length coding (CAVLC) operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 118. For instance, the bitstream may include data that represents a RQT for a CU.

In some examples, residual coding is not performed with palette coding. Accordingly, video encoder 20 may not perform transformation or quantization when coding using a palette coding mode. In addition, video encoder 20 may entropy encode data generated using a palette coding mode separately from residual data.

According to one or more of the techniques of this disclosure, video encoder 20, and specifically palette-based encoding unit 122, may perform palette-based video coding of predicted video blocks. As described above, a palette generated by video encoder 20 may be explicitly encoded and sent to video decoder 30, predicted from previous palette entries, predicted from previous pixel values, or a combination thereof.

As described above, the term “uiIdx” is used herein indicate the scanning order index (e.g., similar to a scanning order serial number) of a sample of the palette-coded block. In instances of horizontal traverse scanning order, the uiIdx of a sample that has the first position within a scan-line is an integer multiple of the width of the block (the width being expressed in terms of a number of samples). For example, in the case of a block that is 8 samples wide, the uiIdx of the first sample of the first scan-line is 0, the uiIdx of the first sample of the second scan-line is 8, the uiIdx of the third scan-line is 16, and so on. Palette-based encoding unit 122 may implement the techniques of this disclosure to “split” the encoding process, based on the position within a scan-line at which a run begins, and the position within a scan-line at which the run ends. First, palette-based encoding unit 122 may determine whether a run starts at the beginning, i.e., at the first scanned sample, of a given line. For instance, palette-based encoding unit 122 may identify a sample as the first sample in a scan-line if the uiIdx of the sample is an integer multiple of the width of the current block.

If palette-based encoding unit 122 determines that the run does not start at the beginning of a scan-line, then palette-based encoding unit 122 may encode the index and run value according to any applicable palette-based coding techniques described above, and/or palette-based coding techniques described in the '514 application or in WD2 of HEVC SCC. For instance, if a modulo operation using the uiIdx of the initial sample of the run as the dividend and the block width as the divisor yields a non-zero result (remainder), then palette-based encoding unit 122 may determine that the run starts does not start at the beginning of a scan-line. Expressed in programming syntax, such as syntax used in the ‘C’ programming language, palette-based encoding unit 122 may determine that the run does not start at the beginning of the scan-line if ((uiIdx % width)!=0), where uiIdx is the uiIdx of the initial sample of the run.

However, if palette-based encoding unit 122 determines that the run starts at the beginning of a scan-line, then palette-based encoding unit 122 may implement the techniques of this disclosure to generate a flag pertaining to the current run of samples. Expressed in the syntax used in the ‘C’ programming language, palette-based encoding unit 122 may determine that the run starts at the beginning of the scan-line if ((uiIdx % width)==0), where uiIdx is the uiIdx of the initial sample of the run. More specifically, palette-based encoding unit 122 may generate the flag to indicate whether or not the run concludes at the end, i.e. at the final scanned sample, of a scan-line. The flag indicates whether the run concludes at the end of any scan-line, including but not limited to the scan-line in which the run begins. The flag is denoted by the “end_line_flag” syntax element in some use cases.

For instance, palette-based encoding unit 122 may set the flag to a value of 1 to indicate that the run concludes at the end of a scan-line. In this scenario, based on the run concluding at the end of a scan-line, palette-based encoding unit 122 may generate an indication of the total number of lines encompassed by the run. For instance, if the run begins and ends in the same line (in this case, spanning exactly one line), then palette-based encoding unit 122 may generate an indication that the number of lines in the run is 1. As another example, if the run concludes at the end of the scan-line that is positioned immediately adjacent to (e.g., below) the scan-line in which the run began, then then palette-based encoding unit 122 may generate an indication that the number of lines in the run is 2

As an example, if palette-based encoding unit 122 determines that the conditions are met for the flag to be set to a value of 1, then palette-based encoding unit 122 may generate the value of the number of lines encompassed by the run, decremented by 1. In this example, if the total number of lines encompassed by the run is denoted by ‘n,’ then palette-based encoding unit 122 may generate the value of (n−1) to indicate the run length in terms of lines. For instance, palette-based encoding unit 122 may generate a value of 0 to indicate a run that begins and concludes in the same line. Palette-based encoding unit 122 may generate a value of 1 to indicate a run that concludes in the immediately adjacent line, and so on.

As another example, palette-based encoding unit 122 may use the value of 0 to indicate that the run encompasses the entire remainder of the block. More specifically, according to this example, if palette-based encoding unit 122 determines that the conditions are met to set the flag to 1, and that the run concludes at the final sample of the bottommost line of the block, then palette-based encoding unit 122 may generate data indicating the run length using a value of 0, regardless of the actual number of lines encompassed by the run. According to this example implementation, if palette-based encoding unit 122 determines that the conditions are met for the flag to be set to 1, but that the run concludes at the end of a scan-line other than the bottommost line of the block, then palette-based encoding unit 122 may generate the actual value of ‘n’ to indicate the number of lines encompassed by the run. In this example, if the run concludes at the end of the scan-line immediately adjacent to the scan-line in which the run began, then, provided that the immediately adjacent line is not the bottommost line of the block, palette-based encoding unit 122 may generate a value of 2 to indicate the run length. As another example, according to this implementation, palette-based encoding unit 122 may generate a value of 1 to indicate a run that begins and concludes in the same line, provided that the scan-line of the run is not the bottommost scan-line of the block. In some examples, palette-based encoding unit 122 may apply the above-described technique of coding the number of lines only when the run is not the very first run in the block, i.e., when the uiIdx of the first sample of the run is not equal to 0.

In some examples, palette-based encoding unit 122 may encode the number of lines in the run using a Golomb code family, such as one or both of a Golomb Rice code, an exponential Golomb code, a Unary code, or a concatenation of Golomb Rice and exponential Golomb code.

Although described as being independent of a maximum value constraint, the techniques for coding the run length information using a concatenation of Golomb Rice and exponential Golomb code may be used in combination with any of the other techniques discussed above. In some examples, palette-based encoding unit 122 may truncate the code used to encode the run length information in terms of a number of lines. For instance, palette-based encoding unit 122 may truncate the code by a number of line-ending samples positioned between the run-starting sample and the end of the run. As another example, palette-based encoding unit 122 may truncate the code by 1 less than the number of line-ending samples positioned between the run-starting sample and the end of the run.

If palette-based encoding unit 122 determines that the run starts at the beginning of the scan-line and does not conclude at the end of a scan-line, then palette-based encoding unit 122 may set the flag (e.g., the end_line_flag) to a value of 0. More specifically, palette-based encoding unit 122 may determine that the run does not conclude at the end of a scan-line if the final sample of the run is not the final sample, in scanning order, of a scan-line. The uiIdx of the final sample of a scan-line is a non-zero integer multiple of the value of ‘width,’ reduced by 1, where ‘width’ denotes the number of samples in a row of a palette-coded block processed according to horizontal traverse scanning. For example, in the case of a block that is 8 samples wide, the final sample of the first line has a uiIdx value of 7, the final sample of the second line of the block has a uiIdx value of 15, and so on. Expressed in the syntax of the ‘C’ programming language, palette-based encoding unit 122 may identify the final sample of a scan-line if the uiIdx of the sample satisfies the condition ((uiIdx+1)% width==0). Conversely, palette-based encoding unit 122 may determine that a sample is not the final sample of its respective line if the uiIdx of the sample satisfies the condition ((uiIdx+1)% width!=0).

In some examples in which palette-based encoding unit 122 determines that conditions call for the flag to be set to the 0 value, palette-based encoding unit 122 may implement techniques of this disclosure to efficiently generate accurate data reflecting the run length, in addition to generating the flag, when the run starts at the beginning of a scan-line, to indicate that the run does not conclude at the end of a scan-line. According to one example implementation, palette-based encoding unit 122 may decrement the run length by a number of ineligible run length values. By decrementing the run length value, palette-based encoding unit 122 may reduce the number of bits required to be encoded, and may reduce the network bandwidth required to transmit the encoded run length value. Based on the flag being set to the 0 value, palette-based encoding unit 122 may determine that various end positions for the run are not possible. As discussed above, if a run concludes at the final sample of a scan-line, then palette-based encoding unit 122 sets the flag to a value of 1, in accordance with the techniques disclosed herein. Thus, palette-based encoding unit 122 may determine, based on the flag being set to a value of 0, that all end-of-line samples encompassed in the run are ineligible to be the concluding point of the run. In other words, palette-based encoding unit 122 may detect “holes” in the set of possible run length values, because certain run length values would cause the run to conclude at the final sample of a scan-line.

To potentially reduce the number of bits required to encode the run length in cases of the flag being set to 0, palette-based encoding unit 122 may decrement the run length by the number of end-of-line instances included in the run. For instance, if the run concludes in the scan-line immediately adjacent (e.g., immediately below) the scan-line in which the run began, then palette-based encoding unit 122 may decrement the run length by a value of 1. More specifically, in this particular example, palette-based encoding unit 122 determines that the run includes exactly 1 end-of-line sample, namely, the final sample of the scan-line in which the run begins. If the run ends in a scan-line that is 2 lines away (e.g., below) the scan-line in which the run began, then palette-based encoding unit 122 may decrement the run length by 2, and so on. In some examples of horizontal traverse scanning, palette-based encoding unit 122 may determine the number of end-of-line samples in the run by dividing the run length (in samples) by the width of the block (in number of samples). For instance, palette-based encoding unit 122 may discard the remainder of the division operation, and use the quotient of division operation as the number of end-of-line samples by which to decrement the run length. Expressed in a different way, palette-based encoding unit 122 may perform a module operation using the run length as the dividend operand and the block width as the divisor operand, and use the result of the modulo operation as the amount by which to decrement the run length.

According to another implementation, if palette-based encoding unit 122 determines that the flag is set to the 0 value, then palette-based encoding unit 122 may generate the number of complete scan-lines included in the run, as well as the number of samples included in the last (incomplete) line of the run to indicate the run length. To obtain the number of samples included in the last incomplete line, palette-based encoding unit 122 may perform a modulo operation with the total run length (expressed as a number of samples) as the dividend and the block width (expressed as a number of samples) as the divisor. Let the number of samples of the run positioned in the last incomplete line be denoted by the symbol ‘k’ and the number of complete lines included in the run be denoted by the symbol ‘n.’ Expressed in the syntax of the ‘C’ programming language, palette-based encoding unit 122 may perform the operation (run % width) to derive the value of k. In the described operation, ‘run’ denotes the length of the run, in terms of a number of samples. The quotient (after discarding the remainder k) resulting from the division operation (run/width) yields the value of n. In turn, palette-based encoding unit 122 may generate the values of n and k to indicate the run length. By enabling video encoder 20 and/or various components thereof to encode and signal the values of n and k, palette-based encoding unit 122 may conserve computing resources and bandwidth that would otherwise be expended by using the actual run length.

In this way, video encoder 20 is an example of a device for coding video data, the device including a memory configured to store at least a portion of the video data, and one or more processors. The one or more processors are configured to: determine whether a palette run starts at a beginning of a scan-line of a block of the video data, when the palette run starts at the beginning of the scan-line, code, for the palette run, a flag that indicates whether the palette run concludes at an end of a scan-line of the block, and code the palette run based on a value of the flag. In some examples, to code the palette run based on the value of the flag, the one or more processors are configured to perform one of: when the flag indicates that the palette run concludes at the end of a scan-line, code a run value to indicate a number of scan-lines included in the palette run, or when the flag indicates that the palette run does not conclude at the end of a scan-line, code the run value to indicate a number of samples included in the palette run.

In some examples, to code the run value when the flag indicates that the palette run concludes at the end of a scan-line, the one or more processors are configured to code the run value to equal one less than the number of scan-lines included in the palette run. According to some examples, when the flag indicates that the palette run concludes at the end of a scan-line, to code the run value, the one or more processors are configured to perform one of: code a value of zero when the palette run concludes at an end of a block, or code the run value includes coding a value other than zero to indicate that the palette run concludes before the end of the block.

According to some examples, to code the run value when the flag indicates that the palette run does not conclude at the end of a scan-line, the one or more processors are configured to code the run value by decrementing a number of samples between a start of the palette run and an end of the palette run in scanning order by a number of scan-line-ending samples included in the palette run. According to some examples, to code the run value when the flag indicates that the palette run does not conclude at the end of a scan-line, the one or more processors are configured to: code a first value representing the number of scan-lines included in the palette run, and code a second value representing a number of samples included in a final scan-line of the palette run.

FIG. 3 is a block diagram illustrating an example video decoder 30 that is configured to implement the techniques of this disclosure. FIG. 3 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 3, video decoder 30 includes a video data memory 148, an entropy decoding unit 150, a prediction processing unit 152, an inverse quantization unit 154, an inverse transform processing unit 156, a reconstruction unit 158, a filter unit 160, and a decoded picture buffer 162. Prediction processing unit 152 includes a motion compensation unit 164 and an intra-prediction processing unit 166. Video decoder 30 also includes a palette-based decoding unit 165 configured to perform various aspects of the palette-based coding techniques described in this disclosure. In other examples, video decoder 30 may include more, fewer, or different functional components.

Video data memory 148 may store video data, such as an encoded video bitstream, to be decoded by the components of video decoder 30. The video data stored in video data memory 148 may be obtained, for example, from channel 16, e.g., from a local video source, such as a camera, via wired or wireless network communication of video data, or by accessing physical data storage media. Video data memory 148 may form a coded picture buffer (CPB) that stores encoded video data from an encoded video bitstream. Decoded picture buffer 162 may be a reference picture memory that stores reference video data for use in decoding video data by video decoder 30, e.g., in intra- or inter-coding modes. Video data memory 148 and decoded picture buffer 162 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 148 and decoded picture buffer 162 may be provided by the same memory device or separate memory devices. In various examples, video data memory 148 may be on-chip with other components of video decoder 30, or off-chip relative to those components.

Video data memory 148, i.e., a CPB, may receive and store encoded video data (e.g., NAL units) of a bitstream. Entropy decoding unit 150 may receive encoded video data (e.g., NAL units) from video data memory 148 and may parse the NAL units to decode syntax elements. Entropy decoding unit 150 may entropy decode entropy-encoded syntax elements in the NAL units. Prediction processing unit 152, inverse quantization unit 154, inverse transform processing unit 156, reconstruction unit 158, and filter unit 160 may generate decoded video data based on the syntax elements obtained (e.g., extracted) from the bitstream.

The NAL units of the bitstream may include coded slice NAL units. As part of decoding the bitstream, entropy decoding unit 150 may extract and entropy decode syntax elements from the coded slice NAL units. Each of the coded slices may include a slice header and slice data. The slice header may contain syntax elements pertaining to a slice. The syntax elements in the slice header may include a syntax element that identifies a PPS associated with a picture that contains the slice.

In addition to decoding syntax elements from the bitstream, video decoder 30 may perform a reconstruction operation on a non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct residual blocks of the CU.

As part of performing a reconstruction operation on a TU of a CU, inverse quantization unit 154 may inverse quantize, i.e., de-quantize, coefficient blocks associated with the TU. Inverse quantization unit 154 may use a QP value associated with the CU of the TU to determine a degree of quantization and, likewise, a degree of inverse quantization for inverse quantization unit 154 to apply. That is, the compression ratio, i.e., the ratio of the number of bits used to represent original sequence and the compressed one, may be controlled by adjusting the value of the QP used when quantizing transform coefficients. The compression ratio may also depend on the method of entropy coding employed.

After inverse quantization unit 154 inverse quantizes a coefficient block, inverse transform processing unit 156 may apply one or more inverse transforms to the coefficient block in order to generate a residual block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If a PU is encoded using intra prediction, intra-prediction processing unit 166 may perform intra prediction to generate predictive blocks for the PU. Intra-prediction processing unit 166 may use an intra prediction mode to generate the predictive luma, Cb and Cr blocks for the PU based on the prediction blocks of spatially-neighboring PUs. Intra-prediction processing unit 166 may determine the intra prediction mode for the PU based on one or more syntax elements decoded from the bitstream.

Prediction processing unit 152 may construct a first reference picture list (RefPicList0) and a second reference picture list (RefPicList1) based on syntax elements extracted from the bitstream. Furthermore, if a PU is encoded using inter prediction, entropy decoding unit 150 may extract motion information for the PU. Motion compensation unit 164 may determine, based on the motion information of the PU, one or more reference regions for the PU. Motion compensation unit 164 may generate, based on samples blocks at the one or more reference blocks for the PU, predictive blocks (e.g., predictive luma, Cb and Cr blocks) for the PU.

Reconstruction unit 158 may use the transform blocks (e.g., luma, Cb and Cr transform blocks) associated with TUs of a CU and the predictive blocks (e.g., luma, Cb and Cr blocks) of the PUs of the CU, i.e., either intra-prediction data or inter-prediction data, as applicable, to reconstruct the coding blocks (e.g., luma, Cb and Cr coding blocks) of the CU. For example, reconstruction unit 158 may add samples of the transform blocks (e.g., luma, Cb and Cr transform blocks) to corresponding samples of the predictive blocks (e.g., predictive luma, Cb and Cr blocks) to reconstruct the coding blocks (e.g., luma, Cb and Cr coding blocks) of the CU.

Filter unit 160 may perform a deblocking operation to reduce blocking artifacts associated with the coding blocks (e.g., luma, Cb and Cr coding blocks) of the CU. Video decoder 30 may store the coding blocks (e.g., luma, Cb and Cr coding blocks) of the CU in decoded picture buffer 162. Decoded picture buffer 162 may provide reference pictures for subsequent motion compensation, intra prediction, and presentation on a display device, such as display device 32 of FIG. 2. For instance, video decoder 30 may perform, based on the blocks (e.g., luma, Cb and Cr blocks) in decoded picture buffer 162, intra prediction or inter prediction operations on PUs of other CUs. In this way, video decoder 30 may extract, from the bitstream, transform coefficient levels of a significant coefficient block, inverse quantize the transform coefficient levels, apply a transform to the transform coefficient levels to generate a transform block, generate, based at least in part on the transform block, a coding block, and output the coding block for display.

In accordance with various examples of this disclosure, video decoder 30 may be configured to perform palette-based coding. Palette-based decoding unit 165, for example, may perform palette-based decoding when a palette-based decoding mode is selected, e.g., for a CU or PU. For example, palette-based decoding unit 165 may be configured to generate a palette having entries indicating pixel values. Furthermore, in this example, palette-based decoding unit 165 may receive information associating at least some positions of a block of video data with entries in the palette. In this example, palette-based decoding unit 165 may select pixel values in the palette based on the information. Additionally, in this example, palette-based decoding unit 165 may reconstruct pixel values of the block based on the selected pixel values. Although various functions are described as being performed by palette-based decoding unit 165, some or all of such functions may be performed by other processing units, or a combination of different processing units.

Palette-based decoding unit 165 may receive palette coding mode information, and perform the above operations when the palette coding mode information indicates that the palette coding mode applies to the block. When the palette coding mode information indicates that the palette coding mode does not apply to the block, or when other mode information indicates the use of a different mode, palette-based decoding unit 165 decodes the block of video data using a non-palette based coding mode, e.g., such an HEVC inter-predictive or intra-predictive coding mode, when the palette coding mode information indicates that the palette coding mode does not apply to the block. The block of video data may be, for example, a CU or PU generated according to an HEVC coding process. A video decoder 30 may decode some blocks with inter-predictive temporal prediction or intra-predictive spatial coding modes and decode other blocks with the palette-based coding mode. The palette-based coding mode may comprise one of a plurality of different palette-based coding modes, or there may be a single palette-based coding mode.

According to one or more of the techniques of this disclosure, video decoder 30, and specifically palette-based decoding unit 165, may perform palette-based video decoding of palette-coded video blocks. As described above, a palette decoded by video decoder 30 may be explicitly encoded and signaled by video encoder 20, reconstructed by video decoder 30 with respect to a received palette-coded block, predicted from previous palette entries, predicted from previous pixel values, or a combination thereof.

Palette-based decoding unit 165 may be configured to perform operations that are reciprocal to those described above with respect to palette-based encoding unit 122 of video encoder 20, to reconstruct a block of encoded video data that was encoded according to one of the palette-based coding modes. As described above, in instances of horizontal traverse scanning order, the uiIdx of a sample that has the first position within a scan-line is an integer multiple of the width of the block (the width being expressed in terms of a number of samples). For example, in the case of a block that is 8 samples wide, the uiIdx of the first sample of the first line is 0, the uiIdx of the first sample of the second line is 8, the uiIdx of the third line is 16, and so on. For instance, palette-based decoding unit 165 may implement the techniques of this disclosure to split the decoding process of a palette-coded block, using a value of a flag received in the encoded video bitstream over channel 16. In scenarios where palette-based decoding unit 165 determines that a run does not begin at the start of a scan-line, and/or decoding techniques described in the '514 application or in WD2 of HEVC SCC.

In cases where palette-based decoding unit 165 determines that a run does begin at the start of a respective scan-line, palette-based decoding unit 165 may use the value of the received flag to determine whether or not the run concludes at the end, i.e. at the final scanned sample, of a scan-line. More specifically, palette-based decoding unit 165 may use the value of the flag to determine whether the run concludes at the end of any scan-line, including but not limited to the scan-line in which the run begins.

For instance, if the flag is set to a value of 1, palette-based decoding unit 165 may determine that the run concludes at the end of a scan-line. As an example, if a received end_line_flag is set to a value of 1, then palette-based decoding unit 165 may determine that the uiIdx of the last sample of the run meets the condition (uiIdx % (width−1)==0). In this scenario, based on the run concluding at the end of a scan-line, palette-based decoding unit 165 may decode an indication of the total number of lines encompassed by the run. For instance, if the run begins and ends in the same line (in this case, the run spanning exactly one line), then palette-based decoding unit 165 may decode an indication that the number of lines in the run is 1. As another example, if the run concludes at the end of the scan-line that is positioned immediately adjacent to (e.g., below) the scan-line in which the run began, then then palette-based decoding unit 165 may decode an indication that the number of scan-lines in the run is 2.

According to some implementations, if the flag is set to a value of 1, then palette-based decoding unit 165 may receive and decode a decremented version of the number of lines encompassed by the run. As one example, palette-based decoding unit 165 receives an indication in the form of a value equal to the number of lines encompassed by the run, decremented by 1. In this example, if the total number of lines encompassed by the run is denoted by ‘n,’ then palette-based decoding unit 165 may recover the value of (n−1), from which palette-based decoding unit 165 may derive the run length in terms of lines (e.g., by incrementing the received value by 1). For instance, if palette-based decoding unit 165 decodes a value of 0 for the run length, then palette-based decoding unit 165 may determine that the run is a one-line run, i.e. that the run begins and concludes in the same line. If palette-based decoding unit 165 decodes a value of 1, palette-based decoding unit 165 may determine that the run concludes in the immediately adjacent line, and so on.

According to some implementations, palette-based decoding unit 165 may determine, based on the received run length indication having a value of 0, that the run encompasses the entire remainder of the block. More specifically, according to this example, if palette-based decoding unit 165 receives a flag set to the value of 1, and that the received run length indicator has a value of 0, then palette-based decoding unit 165 may determine that the run concludes at the final sample of the bottommost line of the block, regardless of the actual number of lines encompassed by the run. According to this example implementation, if palette-based decoding unit 165 determines that the received flag has a value of 1, and receives a non-zero value to indicate the run length, palette-based decoding unit 165 may decode the received run length indication to directly obtain the actual value of the run length. More specifically, in this example, if palette-based decoding unit 165 receives a value denoted by ‘n’ as the run length indicator, then palette-based decoding unit 165 may determine that the value of n equals the actual number of lines encompassed by the run. In this example, palette-based decoding unit 165 may decode a value of 2 from the received indication of the run length, if the run concludes at the end of the scan-line immediately adjacent to the scan-line in which the run began, then, provided that the immediately adjacent line is not the bottommost line of the block. As another example, according to this implementation, palette-based decoding unit 165 may decode a run length indicator value of 1, if the run begins and concludes in the same line, provided that the lone line of the run is not the bottommost line of the block. In some implementations, palette-based decoding unit 165 may decode the palette run according to this scheme only in cases where the palette run does not begin at the very first sample in the block, i.e. only when the uiIdx of the first sample of the run is greater than 0.

In some examples, palette-based decoding unit 165 may receive a code or codeword, such as a Golomb Rice code, and exponential Golomb code, a Unary code, or a concatenation of a Golomb Rice code and an exponential Golomb code representing the number of lines in the run. In some examples, palette-based decoding unit 165 may determine that the received code is truncated, such as by a value of one less than the number of end-line samples in the run. In these examples, palette-based decoding unit 165 may reconstruct the received code, and look up the corresponding number of lines represented by the received code, by matching the reconstructed code to a code that is accessible to palette-based decoding unit 165 or any other component of video decoder 30.

If palette-based decoding unit 165 receives an end_line_flag set to a 0 value, then palette-based decoding unit 165 may determine that the run starts at the beginning of the scan-line, but does not conclude at the end of a scan-line. Based on receiving the end_line_flag set to the 0 value, palette-based decoding unit 165 may determine that the run does not conclude at the end of a scan-line, i.e. that the last sample of the run is not the final sample, in scanning order, of a respective line. In these instances, the concluding sample of the run is not an end-of-line sample. In other words, in these instances, the uiIdx of the run-concluding sample meets the condition (uiIdx % (width−1) !=0). In some examples in which palette-based decoding unit 165 determines that the flag is set to the 0 value, palette-based decoding unit 165 may implement techniques of this disclosure to efficiently decode run length-indicating data, while maintaining accuracy and picture quality.

According to one example implementation, palette-based decoding unit 165 may increment the received run length-indicating information by a number of ineligible run length values. More specifically, in these examples, palette-based decoding unit 165 may increment the received value based on video encoder 20 having decremented the run length value by a commensurate amount. By obtaining the actual run length from a received decremented run length value, palette-based decoding unit 165 may reduce the number of bits required to be decoded, and may reduce the network bandwidth required by another device (e.g., video encoder 20) to transmit the encoded run length value.

Based on the flag being set to the 0 value, palette-based decoding unit 165 may determine that various end positions for the run are not possible. As discussed above, if a run concludes at the final sample of a scan-line, then palette-based decoding unit 165 decodes a value of 1, with respect to the end_line_flag. Thus, palette-based decoding unit 165 may determine, based on the flag being set to a value of 0, that all end-of-line samples encompassed in the run are ineligible to be the concluding point of the run. In other words, palette-based decoding unit 165 may identify “holes” or “gaps” in the set of possible run length values, because certain run length values would cause the run to conclude at the final sample of a scan-line (thereby causing the end_of_line flag to have a value of 1).

Based on bitrate-reducing decrementing that video encoder 20 may perform with respect to the signaled run length indication, palette-based decoding unit 165 may increment the received run length indication by the number of end-of-line instances included in the run. For instance, if the run concludes in the scan-line immediately adjacent (e.g., immediately below) the scan-line in which the run began, then palette-based decoding unit 165 may increment the run length-indicating information by a value of 1. According to this particular example, palette-based decoding unit 165 determines that the run includes exactly 1 end-of-line sample, namely, the final sample of the scan-line in which the run begins. In turn, palette-based decoding unit 165 determines that video encoder 20 decremented the run length by a value of 1 before signaling, and therefore compensates by incrementing the received information by a value of 1. If the run ends in a scan-line that is 2 scan-lines away (e.g., below) the scan-line in which the run began, then palette-based decoding unit 165 may increment the run length by 2, and so on.

In some examples of horizontal traverse scanning, palette-based decoding unit 165 may determine the number of end-of-line samples in the run by dividing the run length (in samples) by the width of the block (in number of samples). For instance, palette-based decoding unit 165 may discard the remainder of the division operation, and use the quotient of division operation as the number of end-of-line samples by which to decrement the run length. Expressed in a different way, palette-based decoding unit 165 may perform a modulo operation using the run length as the dividend operand and the block width as the divisor operand, and use the result of the modulo operation as the amount by which to decrement the run length.

According to another implementation, if palette-based decoding unit 165 determines that the flag is set to the 0 value, then palette-based decoding unit 165 may decode data indicating the number of complete scan-lines included in the run, as well as data indicating the number of samples included in the last (incomplete) scan-line of the run to indicate the run length. Palette-based decoding unit 165 may receive and decode the value ‘n’ representing the number of lines wholly included (i.e. complete scan-lines) in the run, and the value ‘k’ representing the number of samples in the final incomplete scan-line of the run. In turn, palette-based decoding unit 165 may solve the equation run length=(n*width−1)+k to obtain the actual run length, expressed as a number of samples. Palette-based decoding unit 165 may have access to the width of the block (in samples), thereby enabling palette-based decoding unit 165 to substitute the actual width of a given block into the formula above, to thereby obtain the run length.

In this way, video decoder 30 is an example of a device for coding video data, the device including a memory configured to store at least a portion of the video data, and one or more processors. The one or more processors are configured to: determine whether a palette run starts at a beginning of a scan-line of a block of the video data, when the palette run starts at the beginning of the scan-line, code, for the palette run, a flag that indicates whether the palette run concludes at an end of a scan-line of the block, and code the palette run based on a value of the flag. In some examples, to code the palette run based on the value of the flag, the one or more processors are configured to perform one of: when the flag indicates that the palette run concludes at the end of a scan-line, code a run value to indicate a number of scan-lines included in the palette run, or when the flag indicates that the palette run does not conclude at the end of a scan-line, code the run value to indicate a number of samples included in the palette run. In some examples, to code the run value when the flag indicates that the palette run concludes at the end of a scan-line, the one or more processors are configured to code the run value to equal one less than the number of scan-lines included in the palette run.

According to some examples, the one or more processors are further configured to receive the run value as part of an encoded video bitstream, and to code the run value, the one or more processors are configured to entropy decode the run value and incrementing the decoded run value by one to obtain the number of scan-lines included in the palette run. In some examples, when the flag indicates that the palette run concludes at the end of a scan-line, to code the run value, the one or more processors are configured to perform one of: code a value of zero when the palette run concludes at an end of a block, or code the run value includes coding a value other than zero to indicate that the palette run concludes before the end of the block.

In some examples, the one or more processors are further configured to receive the flag and the run value as part of an encoded video bitstream, and to code the run value when the flag indicates that the palette run does not conclude at the end of a scan-line, the one or more processors are configured to decode the run value by incrementing a number of samples between a start of the palette run and an end of the palette run in scanning order by a number of scan-line-ending samples included in the palette run. In some examples, to code the run value when the flag indicates that the palette run does not conclude at the end of a scan-line, the one or more processors are configured to code the run value by decrementing a number of samples between a start of the palette run and an end of the palette run in scanning order by a number of scan-line-ending samples included in the palette run.

According to some examples, to code the run value when the flag indicates that the palette run does not conclude at the end of a scan-line, the one or more processors are configured to: code a first value representing the number of scan-lines included in the palette run, and code a second value representing a number of samples included in a final scan-line of the palette run. In some examples, the one or more processors are further configured to receive the first value and the second value as part of an encoded video bitstream, and to determine that a total number of samples included in the palette run is represented by the formula [(n*width)−1+k], where ‘n’ represents the first value and ‘k’ represents the second value.

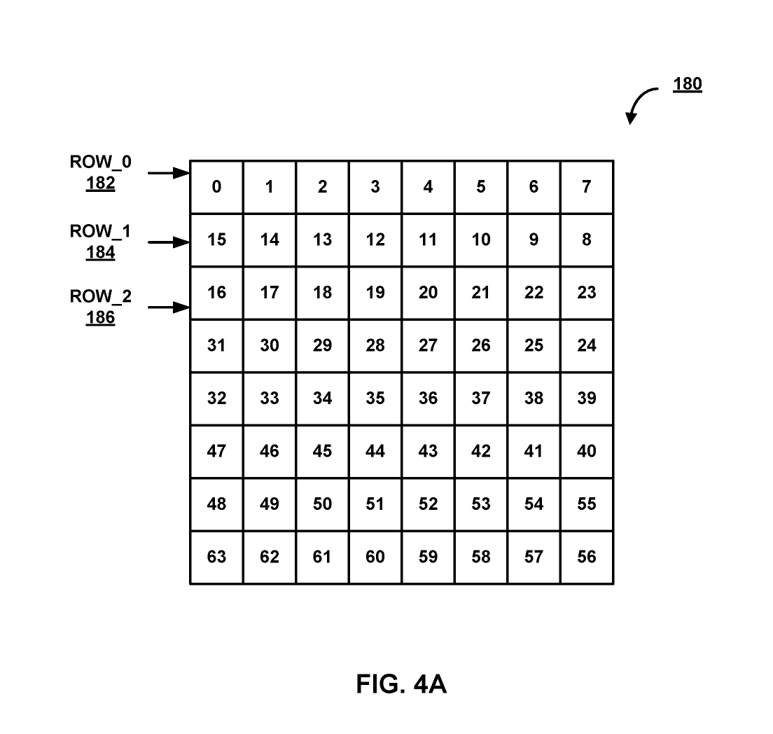

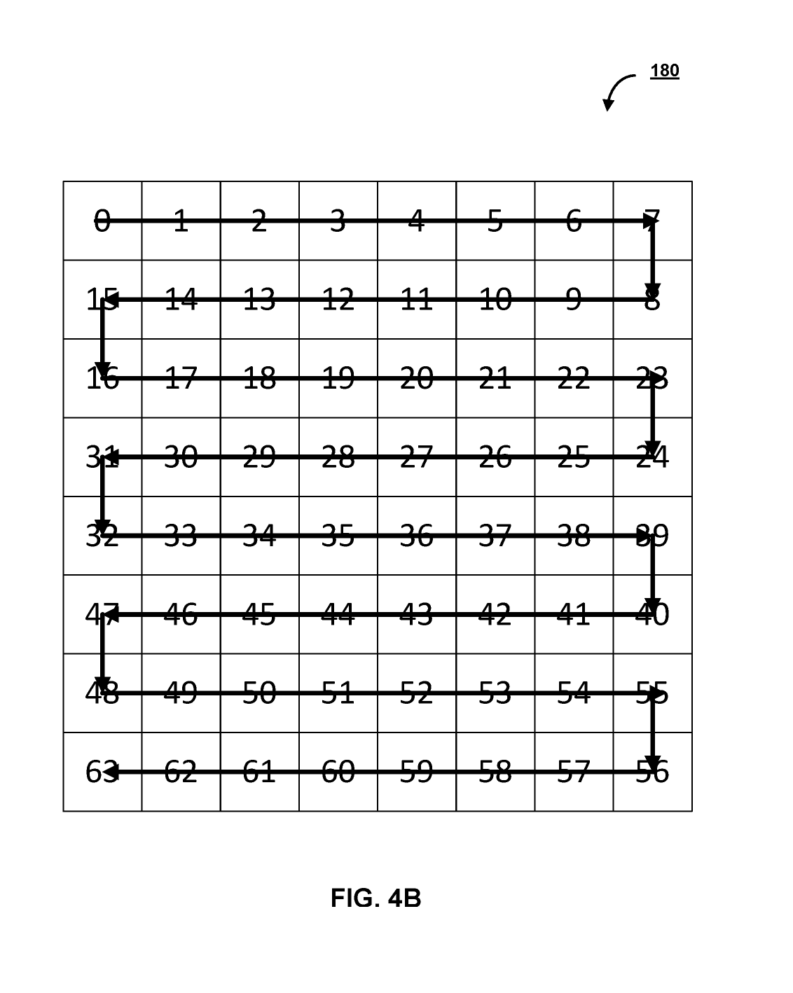

FIGS. 4A and 4B are block diagrams illustrating an example block 180 for coding of palette indices. FIG. 4A illustrates the uiIdx values of each sample of the block. Block 180 is a square block, with an 8-by-8 dimensionality. It will be appreciated that the techniques of this disclosure are equally applicable to palette-based coding of blocks having various dimensionalities, and are not limited to the 8-by-8 dimensionality illustrated with respect to example of block 180. In various examples, video coding devices, such as video encoder 20 and/or video decoder 30, may implement the techniques of this disclosure with respect to square blocks having different dimensionalities from the illustrated 8-by-8 dimensionality, or to non-square rectangular blocks of varying dimensionalities. The uiIdx values illustrated with respect to block 180 reflect a horizontal traverse scanning order, as the uiIdx values increase in increments of 1 in left-to-right and right-to-left directions, alternating on a line-by-line basis.

The uiIdx of a sample that has the first position within a particular line of block 180 is an integer multiple of the width of block 180 (in this case, an integer multiple of 8). With respect to block 180, the uiIdx of the first sample of the first line (row_0 182) is 0, the uiIdx of the first sample of the second line (row_1 184) is 8, the uiIdx of the third line (row_2 186) is 16, and so on. Video coding devices that code or otherwise process block 180 using any of the palette-based coding modes may identify a sample as the first sample in a scan-line if the uiIdx of the sample is an integer multiple of the width (in this case, 8) of block 180. The uiIdx of the final sample of a scan-line of block 180 is a non-zero integer multiple of the value of ‘width’ reduced by 1. As described, in the case of block 180, the value of the ‘width’ variable is 8. In the case of block 180, the final sample of the first line (row_0 182) has a uiIdx value of 7, the final sample of the second line (row_1 184) of the block has a uiIdx value of 15, the final sample of the third line (row_2 186) is 23, and so on.

FIG. 4B is a block diagram illustrating block 180 with a scan line 190, to illustrate the path of a horizontal traverse scan that video encoder 20 and/or video decoder 30 may apply for coding of the palette indices of block 180. In coding of palette indices, an alternating or traverse scan is used. For example, if the scan direction is horizontal, for the first row, the scan is from left to right and for the second row, the scan is from right to left, and so on. The horizontal scan direction is shown in FIG. 4B, with respect to block 180. Similarly for vertical scan, the scan alternates between top to bottom and bottom to top. The scan converts a two-dimensional block to one dimension. Let the index of a sample in the scan order be denoted by uiIdx. The index takes the values between 0 and (width*height−1), inclusive. In the current working draft, the width and height are always equal. But the techniques of this disclosure are applicable to non-square blocks as well. In FIG. 4B, the numbers inside the squares correspond to uiIdx.

For a sample at the beginning of the line, uiIdx is an integer multiple of the width. This can be expressed in C syntax as ((uiIdx % width)==0). In FIG. 4B, position with uiIdx equal to 0, 8, 16, 24, 32, 40, 48 and 56 are at the beginning of the line. It is proposed that when the run is originating in a sample/pixel that is at the beginning of the line and the run is an index run, a different method of run coding is used.

In one example method, when the run originates at the beginning of the line, a flag (end_line_flag) is coded to indicate whether the run ends at the end of the current line or at the end of any other line. For example, with reference to FIG. 4B, if the run starts at uiIdx equal to 40 and ends at 47, 55 or 63, then it is ending at the end of a line. This can be expressed as run=(n*width−1), where n is a positive integer. If the flag is 1, the number of lines minus one (n−1) for which the run continues is coded. If the run ends on the current line, the number of lines is 1. For example, if a run starts at the beginning of a line, end_line_flag equal to 1 may indicate that the run ends at the end of a line, while end_line_flag equal to 0 may indicate that the run ends somewhere other than the end of a line. Furthermore, if end_line_flag equals 1, the run value, palette_run, may be coded using the number of lines for which the run continues minus one. Thus, if a run starts and ends on the same line, the number of lines would be one, and palette_run may be coded using a value of 0.

In an alternate example method, when uiIdx is greater than 0, video encoder 20 and/or video decoder 30 may code the number of lines as follows. If the run continues to the end of the block, a 0 is coded. Otherwise the actual number of lines (n) is coded. That is, if a run starts at the beginning of a line, end_line_flag equal to 1 may indicate that the run ends at the end of a line, while end_line_flag equal to 0 may indicate that the run ends somewhere other than the end of a line. Furthermore, when the run starts at a pixel/sample having a value of uiIdx greater than 0 (e.g., when the run does not start at the start of the block), if end_line_flag equals 1 and the run continues to the end of the block, then the run value, palette_run, may be coded using a value of 0. If end_line_flag equals 1 and the run does not continue to the end of the block, palette_run may be coded using the number of lines for which the run continues.

It is disclosed herein that Golomb code family, e.g., Golomb Rice code, exponential Golomb code, Unary code, or concatenation of Golomb Rice and exponential Golomb code be used to represent the number of lines in the run. In some examples, truncated versions of these codes may be used. The truncation is based on (one less than) the number of sample/pixels that can be classified as end of the line between the current pixel and the end of the block.

If end_line_flag is equal to 0, it implies that the run ends in the middle of a line. The run as well as the maximum run values are adjusted downwards on the encoder side to account for the fact that run values corresponding to pixel/samples that can be classified as ‘end of line’ are not needed. They are correspondingly incremented on the decoder side. For example, in FIG. 4B, if the run starts on 40 and the end_line_flag is 0, then the run cannot end at positions 47, 55 and 63. Thus, a run that ends between 47 and 55 is adjusted downwards by 1 before coding to account for the fact that it may not end on 47. If a run ends between 55 and 63, it is adjusted downwards by 2 before coding. The maximum run is adjusted downwards by the number of sample/pixels that can be classified as end of the line between the current pixel and the end of the block. In this case, that number is 3. That is, in the example of FIG. 4B, for instance, between the pixel/sample having uiIdx value 40 and the end of the block, there are 3 uiIdx values (e.g., 47, 55, and 63) that are each the end of their respective line. When the end_line_flag is equal to 0, the run cannot end with a pixel/sample that is the end of a line, and therefore, the encoder may adjust the run value itself, as well as the maximum run value, downward.

The same code used in the current working draft for coding the palette runs may be used. Alternatively, any other Golomb code family, e.g., Golomb Rice code, exponential Golomb code, Unary code, or concatenation of Golomb Rice and exponential Golomb code or their truncated versions may be used. The maximum run used for the truncation is modified as described above.

In another example, when end_line_flag is 0, the run is coded as follows. Let the run be equal to: run=(n*width−1)+k. As before, n is a positive integer. Since end_line_flag is 0, 0<k<width. Now n is coded using one of the two embodiments described above. For truncated versions of codes, the number of lines until the end of the block is used to derive a maximum possible value for n. This is calculated as (width*height−uiIdx)/width. The remainder k may be coded using a truncated binary code, a fixed length code or any code in the Golomb family (or their truncated versions) after taking into account that the total number of symbols to be coded is (width−1). For example, if the run starts at uiIdx equal to 24 and the run value is 20. Then, the number of lines n=2 and k=5.

If the run does not begin at the beginning of the line, any method for coding the palette run may be used. For example, one or more of the techniques disclosed in the '514 application may be used. Alternatively, the existing palette run coding method in the current working draft (JCTVC-S1005) may be used.

The run coding methods described herein may be applied to both horizontal and vertical scans and ‘copy above’ runs as well. In summary, this disclosure describes examples of an apparatus for coding video data, the apparatus including means for determining whether a palette run starts at a beginning of a scan-line of a block of the video data, means for coding, when the palette run starts at the beginning of the scan-line, for the palette run, a flag that indicates whether the palette run concludes at an end of a scan-line of the block, and means for coding the palette run based on a value of the flag. In some examples, this disclosure describes a computer-readable storage medium encoded with instructions. The instructions, when executed, cause one or more processors of the device to determine whether a palette run starts at a beginning of a scan-line of a block of the video data, when the palette run starts at the beginning of the scan-line, code, for the palette run, a flag that indicates whether the palette run concludes at an end of a scan-line of the block, and code the palette run based on a value of the flag.

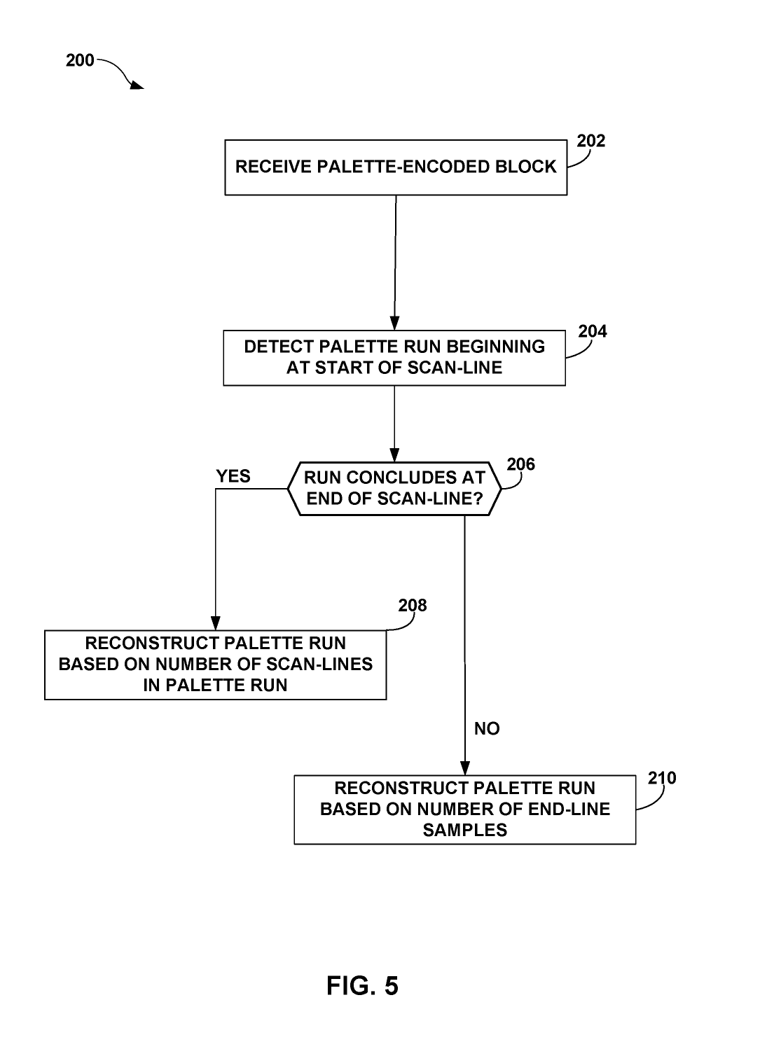

FIG. 5 is a flowchart illustrating an example process 200 by which a video coding device, such as a device configured or otherwise operable to decode encoded video data, may perform one or more techniques of this disclosure. While process 200 may be performed by a variety of devices, process 200 is described herein as being performed by video decoder 30 illustrated in FIGS. 1 and 3, for ease of discussion purposes. Moreover, while various steps of process 200 are illustrated in a particular order for lustration and ease of discussion, it will be appreciated that the order of the steps may vary, certain steps may be optional based on decision tree traversals, and additional steps or sub-steps may be applicable in various scenarios.

Process 200 may begin when video decoder 30 receives a block of video data that is encoded according to one of the palette-based coding modes discussed above (202). For instance, video decoder 30 may receive the palette-coded block as part of an encoded video bitstream signaled by video encoder 20 over channel 16. In turn, video decoder 30 may detect that a palette run begins at the start of a scan-line (204). For instance, video decoder 30 may receive, in association with a run-starting sample of the palette-coded block, an end_line_flag syntax element. Based on the end_line_flag being signaled in association with the sample, video decoder 30 may determine that the sample is the first sample of a palette run, and that the sample is also positioned in the initial scanning position of its respective line within the palette-coded block.

Based on the determination that the palette run begins at the initial scanning position of a scan-line, video decoder 30 may determine whether or not the run concludes at the end of a scan-line of the block (206). For instance, if video decoder 30 determines that the end_line_flag is in an enabled state (e.g., set to a value of 1), then video decoder 30 may determine that the palette run concludes at the end of a scan-line (such as the scan-line in which the run began, or another line positioned below the scan-line in which the run began) of the palette-coded block.

If video decoder 30 determines that the palette run does conclude at the end of a scan-line of the block (‘YES’ branch of decision block 206), then video decoder 30 reconstructs the palette run based on the number of lines the palette run (208). Video decoder 30 may obtain the number of lines in the palette run by decoding and processing run length information signaled in the encoded video bitstream. According to some implementations, video decoder 30 may increment the received raw value by 1, to compensate for a decrementing operation performed by video encoder 20. According to other implementations, video decoder 30 may use the signaled run length value as the actual number of lines in the run. According to implementations where the signaled run length represents the actual number of lines, video decoder 30 may determine that a signaled value of 0 is reserved for a special case. In these cases, because a run length of 0 lines is not possible due to the run beginning at the start of a scan-line and concluding at the end of a scan-line, the run must be at least 1 line long. If the signaled run length in such a case is 0, then video decoder 30 may determine that the run concludes at the last sample of the block. In other words, according to this particular implementation, video decoder 30 may interpret a signaled run length value of 0 to mean that the run encompasses the remainder of the block, beginning from the first sample of the run all the way to the end of the block.

If video decoder 30 determines that the palette run does not conclude at the end of a scan-line (‘NO’ branch of decision block 206), then video decoder 30 reconstructs the palette run based on the number of included in the run (210). For instance, if video decoder 30 determines that the end_line_flag is in an disabled state (e.g., set to a value of 0), then video decoder 30 may determine that the palette run concludes at a sample that is not the final sample of a scan-line of the palette-coded block. According to some implementations, video decoder 30 may determine that the signaled run length value represents a total number of samples in the run, decremented by the number of end-line (or line-ending) samples included in the run. In these implementations, video decoder 30 may determine that end-line samples are ineligible to be the last sample in the run, based on the end_line_flag being disabled. Video decoder 30 may determine that video encoder 20 decremented the actual number of samples in the run by the number of the ineligible end-line samples in the run. Video decoder 30 may therefore compensate by adding the number of end-line samples to the received value, to obtain the actual number of samples included in the palette run. In turn, video decoder 30 may reconstruct the palette by populating the indices of the run with reused indices, derived based on whether the run is encoded using copy mode or index mode.

In other implementations, video decoder 30 may extract two values from the received run length information, namely, the number of complete scan-lines in the run, and the number of samples in the last (and incomplete) scan-line of the run. In these implementations, video decoder 30 may multiply the block width (in terms of samples) by the signaled number of complete scan-lines. Video decoder 30 may add the resulting product to the received number of samples in the last incomplete line, to obtain the total number of samples in the palette run. In turn, video decoder 30 may reconstruct the palette by populating the indices of the run with reused indices, derived based on whether the run is encoded using copy mode or index mode. In some examples, video decoder 30 may only implement decoding according to this scheme in cases where the palette run is to be decoded according to the index mode.

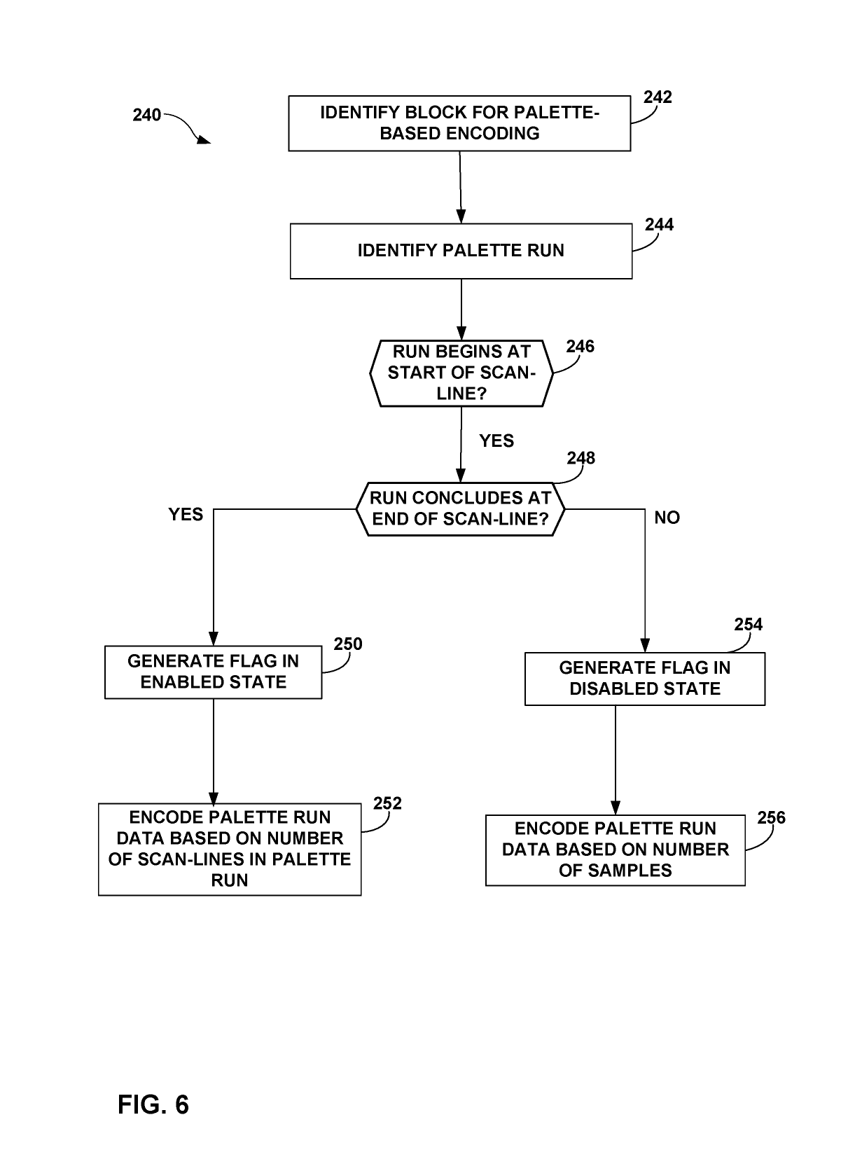

FIG. 6 is a flowchart illustrating an example process 240 by which a video coding device, such as a device configured or otherwise operable to encode video data, may perform one or more techniques of this disclosure. While process 240 may be performed by a variety of devices, process 240 is described herein as being performed by video encoder 20 illustrated in FIGS. 1 and 2, for ease of discussion purposes. Moreover, while various steps of process 240 are illustrated in a particular order for lustration and ease of discussion, it will be appreciated that the order of the steps may vary, certain steps may be optional based on decision tree traversals, and additional steps or sub-steps may be applicable in various scenarios.

Process 240 may begin when video encoder 20 identifies a block of video data that is to be encoded according to one of the palette-based coding modes discussed above (242). In turn, video encoder 20 may identify a palette run within the block (244). Video encoder 20 may determine whether the run begins at the start of the scan-line (246). If video encoder 20 determines that the first sample of the run is positioned at an initial scanning position of a scan-line, then video encoder 20 may determine that the run begins at the start of the scan-line. If video encoder 20 determines that the palette run does not begin at the start of a scan-line, then video encoder 20 may encode the run according to various palette-based coding techniques described above, such as the techniques disclosed in the '514 application. A ‘NO’ branch of decision block 246 is not shown in FIG. 6 for ease of illustration purposes.

If video encoder 20 determines that the run begins at the start of a scan-line (‘YES’ branch of decision block 246), then video encoder 20 may determine whether or not the run concludes at the end of a scan-line of the block (248). For instance, video encoder 20 may determine that the run concludes at the end of a scan-line (e.g., the same line in which the run began, or a scan-line positioned after the run-beginning line in scanning order) if the last sample of the run (i.e., the last sample having the same value as other samples in the run, before a subsequent sample having a different value) is also positioned at the final scanning position of a given line. If video encoder 20 determines that the run concludes at the end of a scan-line (‘YES’ branch of decision block 248), then video encoder 20 may generate a flag in an enabled state (250). For instance, video encoder 20 may set the value of an end_line_flag to a value of 1. In turn, video encoder 20 may encode the palette run data based on a number of lines in the palette run (252). As examples, video encoder 20 may encode an indication of the number of lines decremented by 1, or may encode the actual number of lines in the run, and use the value of 0 to indicate that the palette run encompasses the remainder of the block. In some cases, video encoder 20 may only use the latter scheme if the palette run is to be encoded according to the index mode.

If video encoder 20 determines that the palette run does conclude at the end of a scan-line of the block (‘NO’ branch of decision block 248), then video encoder 20 may generate the flag in a disabled state (254). For instance, video encoder 20 may set the value of an end_line_flag to a value of 0. In turn, video encoder 20 may encode the palette run data based on a number of end-line samples in the palette run (256). As examples, video encoder 20 may encode an indication of the number of samples in the run decremented by the number of end-line samples in the run, or may encode the number of complete scan-lines included in the run, and encode a number of samples included in the last incomplete line of the run.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially. In addition, while certain aspects of this disclosure are described as being performed by a single module or unit for purposes of clarity, it should be understood that the techniques of this disclosure may be performed by a combination of units or modules associated with a video coder.

Certain aspects of this disclosure have been described with respect to the developing HEVC standard for purposes of illustration. However, the techniques described in this disclosure may be useful for other video coding processes, including other standard or proprietary video coding processes not yet developed.

The techniques described above may be performed by video encoder 20 (FIGS. 1 and 2) and/or video decoder 30 (FIGS. 1 and 3), both of which may be generally referred to as a video coder or a video coding device. Likewise, video coding may refer to video encoding or video decoding, as applicable.

While particular combinations of various aspects of the techniques are described above, these combinations are provided merely to illustrate examples of the techniques described in this disclosure. Accordingly, the techniques of this disclosure should not be limited to these example combinations and may encompass any conceivable combination of the various aspects of the techniques described in this disclosure.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining whether a palette run starts at a beginning of a scan-line of a block of the video data;
when the palette run starts at the beginning of the scan-line, coding, for the palette run, a flag that indicates whether the palette run concludes at an end of a scan-line of the block; and
coding the palette run based on a value of the flag.

2. The method of claim 1, wherein coding the palette run based on the value of the flag comprises performing one of:
when the flag indicates that the palette run concludes at the end of a scan-line, coding a run value to indicate a number of scan-lines included in the palette run; or
when the flag indicates that the palette run does not conclude at the end of a scan-line, coding the run value to indicate a number of samples included in the palette run.

3. The method of claim 2, wherein when the flag indicates that the palette run concludes at the end of a scan-line, coding the run value comprises coding the run value to equal one less than the number of scan-lines included in the palette run.

4. The method of claim 3, further comprising receiving the run value as part of an encoded video bitstream, wherein coding the run value comprises entropy decoding the run value and incrementing the decoded run value by one to obtain the number of scan-lines included in the palette run.

5. The method of claim 3, wherein coding the value comprises setting the run value equal to one less than the number of scan-lines included in the palette run and entropy encoding the run value, the method further comprising signaling the encoded value as part of an encoded video bitstream.

6. The method of claim 2, wherein when the flag indicates that the palette run concludes at the end of a scan-line, coding the run value comprises performing one of:
coding a value of zero when the palette run concludes at an end of a block, or
coding the run value comprises coding a value other than zero to indicate that the palette run concludes before the end of the block.

7. The method claim 2, further comprising receiving the flag and the run value as part of an encoded video bitstream, wherein when the flag indicates that the palette run does not conclude at the end of a scan-line, coding the run value comprises decoding the run value by incrementing a number of samples between a start of the palette run and an end of the palette run in scanning order by a number of scan-line-ending samples included in the palette run.

8. The method of claim 2, wherein when the flag indicates that the palette run does not conclude at the end of a scan-line, coding the run value comprises coding the run value by decrementing a number of samples between a start of the palette run and an end of the palette run in scanning order by a number of scan-line-ending samples included in the palette run.

9. The method of claim 2, wherein when the flag indicates that the palette run does not conclude at the end of a scan-line, coding the run value comprises:
coding a first value representing the number of scan-lines included in the palette run; and
coding a second value representing a number of samples included in a final scan-line of the palette run.

10. The method of claim 9, further comprising:
receiving the first value and the second value as part of an encoded video bitstream; and
determining that a total number of samples included in the palette run is represented by the formula [(n*width)−1+k], where ‘n’ represents the first value and ‘k’ represents the second value.

11. A device for coding video data, the device comprising:
a memory configured to store at least a portion of the video data, and
one or more processors configured to:
determine whether a palette run starts at a beginning of a scan-line of a block of the video data;
when the palette run starts at the beginning of the scan-line, code, for the palette run, a flag that indicates whether the palette run concludes at an end of a scan-line of the block; and
code the palette run based on a value of the flag.

12. The device of claim 11, wherein to code the palette run based on the value of the flag, the one or more processors are configured to perform one of:
when the flag indicates that the palette run concludes at the end of a scan-line, code a run value to indicate a number of scan-lines included in the palette run; or
when the flag indicates that the palette run does not conclude at the end of a scan-line, code the run value to indicate a number of samples included in the palette run.

13. The device of claim 12, wherein to code the run value when the flag indicates that the palette run concludes at the end of a scan-line, the one or more processors are configured to code the run value to equal one less than the number of scan-lines included in the palette run.

14. The device of claim 13, wherein the one or more processors are further configured to receive the run value as part of an encoded video bitstream, and wherein to code the run value, the one or more processors are configured to entropy decode the run value and incrementing the decoded run value by one to obtain the number of scan-lines included in the palette run.

15. The device of claim 12, wherein when the flag indicates that the palette run concludes at the end of a scan-line, to code the run value, the one or more processors are configured to perform one of:
code a value of zero when the palette run concludes at an end of a block; or
code the run value comprises coding a value other than zero to indicate that the palette run concludes before the end of the block.

16. The device of claim 12, wherein the one or more processors are further configured to receive the flag and the run value as part of an encoded video bitstream, and wherein to code the run value when the flag indicates that the palette run does not conclude at the end of a scan-line, the one or more processors are configured to decode the run value by incrementing a number of samples between a start of the palette run and an end of the palette run in scanning order by a number of scan-line-ending samples included in the palette run.

17. The device of claim 12, wherein to code the run value when the flag indicates that the palette run does not conclude at the end of a scan-line, the one or more processors are configured to code the run value by decrementing a number of samples between a start of the palette run and an end of the palette run in scanning order by a number of scan-line-ending samples included in the palette run.

18. The device of claim 12, wherein to code the run value when the flag indicates that the palette run does not conclude at the end of a scan-line, the one or more processors are configured to:
code a first value representing the number of scan-lines included in the palette run; and
code a second value representing a number of samples included in a final scan-line of the palette run.

19. The device of claim 18, wherein the one or more processors are further configured to:
receive the first value and the second value as part of an encoded video bitstream; and
determine that a total number of samples included in the palette run is represented by the formula [(n*width)−1+k], where ‘n’ represents the first value and ‘k’ represents the second value.

20. An apparatus for coding video data, the apparatus comprising:
means for determining whether a palette run starts at a beginning of a scan-line of a block of the video data;
means for coding, when the palette run starts at the beginning of the scan-line, for the palette run, a flag that indicates whether the palette run concludes at an end of a scan-line of the block; and
means for coding the palette run based on a value of the flag.
